(19) United States
(12) Patent Application Publication
(10) Pub. No.: US 2023/0368977 A1
(43) Pub. Date: Nov. 16, 2023

(54) Multilayer Ceramic Capacitor Having Ultra-Broadband Performance

(71) Applicant: KYOCERA AVX Components Corporation, Fountain Inn, SC (US)

(72) Inventors: Marianne Berolini, Greer, SC (US); Jeffrey Horn, Simpsonville, SC (US); Fumihiko Hidaka, Kirishima-shi Kagoshima-ken (JP); Yuki Inanaga, Kirishima-shi Kagoshima-ken (JP)

(21) Appl. No.: 18/315,724

(22) Filed: May 11, 2023

Related U.S. Application Data
(60) Provisional application No. 63/341,000, filed on May 12, 2022.

(51) Int. Cl. H01G 4/30; H01G 4/232; H01G 4/12; H01G 4/012; H01G 2/06; H01G 4/008

(52) U.S. Cl. CPC H01G 4/30; H01G 4/232; H01G 4/12; H01G 4/012; H01G 2/065; H01G 4/008

(57) ABSTRACT

A broadband multilayer ceramic capacitor may include a first external termination and a second external termination. A first portion of the first external termination may be spaced apart from a first portion of the second external termination by a first external termination spacing distance. A first active electrode layer may include a rectangular first active electrode connected with the first external termination. A second active electrode layer may include a rectangular second active electrode connected with the second external termination. An outermost active electrode layer closest to an outer surface of the capacitor may be spaced apart from the outer surface by an outermost-active-to-surface distance. A ratio of a capacitor thickness in a Z-direction to the outermost-active-to-surface distance may be 1.1 or more. A ratio of a capacitor length in a longitudinal direction to the first external termination spacing distance may be 15 or more.

### RELATED APPLICATION

The present application is based upon and claims priority to U.S. Provisional Patent Application Ser. No. 63/341,000 having a filing date of May 12, 2022, which is incorporated herein by reference.

### BACKGROUND OF THE INVENTION

The diversity of modern technical applications creates a need for efficient electronic components and integrated circuits for use therein. Capacitors are a fundamental component used for filtering, coupling, bypassing and other aspects of such modern applications which may include wireless communications, alarm systems, radar systems, circuit switching, matching networks, and many other applications. A dramatic increase in the speed and packing density of integrated circuits requires advancements in coupling capacitor technology in particular. When high-capacitance coupling capacitors are subjected to the high frequencies of many present applications, performance characteristics become increasingly more important. Because capacitors are fundamental to such a wide variety of applications, their precision and efficiency are imperative. Many specific aspects of capacitor design have thus been a focus for improving their performance characteristics.

### SUMMARY OF THE INVENTION

In accordance with one embodiment of the present invention, a broadband multilayer ceramic capacitor may include a monolithic body including a plurality of dielectric layers stacked in a Z-direction, and the monolithic body may have a first end opposite a second end. A first external termination may be disposed along the first end of the monolithic body. The first external termination may include a first portion extending along an outer surface of the monolithic body. A second external termination may be disposed along the second end of the monolithic body. The second external termination may include a first portion extending along the outer surface of the monolithic body. The first portion of the first external termination may be spaced apart from the first portion of the second external termination by a first external termination spacing distance. An active electrode region may contain a plurality of first active electrode layers and a plurality of second active electrode layers. The plurality of first active electrode layers may include at least one active electrode that is rectangular in shape. The plurality of second active electrode layers may include at least one second active electrode that is rectangular in shape. The plurality of first active electrode layers may be connected with the first external termination. The plurality of second active electrode layers may be connected with the second external termination. The active electrode region may contain an outermost active electrode layer. The outermost active electrode layer may be spaced apart from the outer surface by an outermost-active-to-surface distance. The monolithic body may have a thickness along the Z-direction. A ratio of the thickness to the outermost-active-to-surface distance may be 1.1 or more. The capacitor may have a capacitor length extending in a longitudinal direction. A ratio of the capacitor length to the first external termination spacing distance may be 15 or more.

In accordance with another embodiment of the present invention, a device may include a mounting surface and a broadband multilayer ceramic capacitor. The broadband multilayer ceramic capacitor may include a monolithic body including a plurality of dielectric layers stacked in a Z-direction, and the monolithic body may have a first end opposite a second end. A first external termination may be disposed along the first end of the monolithic body. The first external termination may include a first portion extending along an outer surface of the monolithic body. A second external termination may be disposed along the second end of the monolithic body. The second external termination may include a first portion extending along the outer surface of the monolithic body. The first portion of the first external termination may be spaced apart from the first portion of the second external termination by a first external termination spacing distance. An active electrode region may contain a plurality of first active electrode layers and a plurality of second active electrode layers. The plurality of first active electrode layers may include at least one active electrode that is rectangular in shape. The plurality of second active electrode layers may include at least one second active electrode that is rectangular in shape. The plurality of first active electrode layers may be connected with the first external termination. The plurality of second active electrode layers may be connected with the second external termination. The active electrode region may contain an outermost active electrode layer. The outermost active electrode layer may be spaced apart from the outer surface by an outermost-active-to-surface distance. The monolithic body may have a thickness along the Z-direction. A ratio of the thickness to the outermost-active-to-surface distance may be 1.1 or more. The capacitor may have a capacitor length extending in a longitudinal direction. A ratio of the capacitor length to the first external termination spacing distance may be 15 or more.

In accordance with yet another embodiment of the present invention, a method of forming a broadband multilayer ceramic capacitor may include forming a plurality of active electrodes on a plurality of active electrode layers. At least one first active electrode layer of the plurality of active electrode layers may comprise a first active electrode. At least one second active electrode layer of the plurality of active electrode layers may comprise a second active electrode. The method may also include stacking the plurality of active electrode layers and a plurality of dielectric layers to form a monolithic body having an outer surface. The plurality of active electrode layers may include an outermost active electrode layer disposed closest to the outer surface of the monolithic body of the plurality of active electrode layers. The method may further include depositing a first external termination along a first end of the capacitor. The first external termination may be connected with the first active electrode layer. The first external termination may include a first portion extending along the outer surface of the capacitor. The method may also comprise depositing a second external termination along a second end of the capacitor that is opposite the first end. The second external termination may be connected with the second active electrode layer. The second external termination may include a first portion extending along the outer surface of the capacitor. The outermost active electrode layer may be spaced apart from the outer surface by an outermost-active-to-surface distance. The monolithic body may have a thickness along the Z-direction. A ratio of the thickness to the outermost-active-to-surface distance may be 1.1 or more. The capacitor may have a capacitor length extending in a longitudinal direction. A ratio of the capacitor length to the first external termination spacing distance may be 15 or more.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1A illustrates a side cross-sectional view of an embodiment of a capacitor according to aspects of the present disclosure;

FIG. 1B illustrates an exploded side view of one embodiment of adjacent active electrode layers of the capacitor of FIG. 1A according to aspects of the present disclosure;

FIG. 2 illustrates a circuit diagram of the embodiment of a capacitor illustrated in FIG. 1A according to aspects of the present disclosure;

FIG. 3A illustrates a shield electrode layer, which may be included in a shield electrode region of various embodiments of a capacitor according to aspects of the present disclosure;

FIG. 3B illustrates another embodiment of a shield electrode layer, which may be included in a shield electrode region of various embodiments of a capacitor according to aspects of the present disclosure;

FIG. 4 illustrates a side cross-sectional view of another embodiment of a capacitor according to aspects of the present disclosure;

FIGS. 5A through 5C illustrate top views of anchor electrodes of the capacitor of FIG. 4 in accordance with various embodiments of the present disclosure;

FIG. 6 illustrates a side cross-sectional view of another embodiment of a capacitor according to aspects of the present disclosure;

FIG. 7 illustrates a side cross-sectional view of yet another embodiment of a capacitor according to aspects of the present disclosure;

FIG. 8A illustrates an exploded side view of one embodiment of adjacent active electrode layers of the capacitor of FIG. 7 according to aspects of the present disclosure;

FIG. 8B illustrates capacitive regions of a first active electrode layer of FIG. 8A according to aspects of the present disclosure;

FIG. 8C illustrates capacitive regions of a second active electrode layer of FIG. 8A according to aspects of the present disclosure;

FIG. 9 illustrates a side cross-sectional view of still another embodiment of a capacitor according to aspects of the present disclosure;

FIG. 10 illustrates a plurality of insertion loss curves for a plurality of capacitors of FIG. 1A according to aspects of the present disclosure;

FIG. 11 illustrates a plurality of insertion loss curves for a plurality of capacitors of FIG. 1A according to aspects of the present disclosure; and

FIG. 12 illustrates a plurality of insertion loss curves for a plurality of capacitors of FIG. 1A according to aspects of the present disclosure.

### DETAILED DESCRIPTION

It is to be understood by one of ordinary skill in the art that the present discussion is a description of exemplary embodiments only and is not intended as limiting the broader aspects of the present invention.

Generally speaking, the present subject matter is directed to a capacitor, such as for broadband and/or ultra-broadband applications. The capacitor includes alternating dielectric layers and electrode layers, which may form at least a part of the monolithic body of the capacitor. By arranging the dielectric layers and the electrode layers in a stacked or laminated configuration, the capacitor may be referred to as a multilayer capacitor and in particular a multilayer ceramic capacitor, for instance when the dielectric layers include a ceramic.

The capacitor may include a monolithic body including a plurality of dielectric layers stacked in a Z-direction. A first external termination can be disposed along a first end of the capacitor. The first external termination can include a first portion that extends along an outer surface of the monolithic body of the capacitor. A second external termination can be disposed along a second end of the capacitor that is opposite the first end in a longitudinal direction. The second external termination can include a first portion that extends along the outer surface of the monolithic body. The first portion of the first external termination and the first portion of the second external termination can be spaced apart in the longitudinal direction by a first external termination spacing distance.

The outer surface can be a top surface of the monolithic body or a bottom surface of the monolithic body of the capacitor. The top surface and the bottom surface of the monolithic body are opposite one another along the Z-direction. In some embodiments, the first external termination and the second external termination each can include a first portion that extends along a first outer surface of the monolithic body, a second portion that extends along a second outer surface of the monolithic body, etc. such that the first external termination and the second external termination extend along more than one outer surface of the monolithic body of the capacitor. For example, in some embodiments, the first external termination can include a second portion that extends along a second outer surface of the monolithic body, and the second external termination can include a second portion that extends along the second outer surface of the monolithic body. The second portion of the first external termination and the second portion of the second external termination can be spaced apart in the longitudinal direction by a second external termination spacing distance. In embodiments of the capacitor including both the first portion of the first external termination, the first portion of the second external termination, the second portion of the first external termination, and the second portion of the second external termination, the first portion of each of the first and second external terminations may extend along one of the top surface and the bottom surface of the monolithic body, and the second portion of each of the first and second external terminations may extend along the other of the top surface and the bottom surface of the monolithic body.

The first external termination spacing distance and/or the second external termination spacing distance can be relatively small such that a fringe effect capacitance is created between the external terminations. The fringe effect capacitance can contribute to the excellent high frequency performance of the capacitor. For example, the capacitor can have a capacitor length in the longitudinal direction between the first end and the second end. A ratio of the capacitor length to the first external termination spacing distance can be greater than about 2, in some embodiments greater than about 3, in some embodiments greater than about 5, in some embodiments greater than about 7, in some embodiments greater than about 10, in some embodiments greater than about 20, in some embodiments greater than about 30, and in some embodiments greater than about 35. Further, a ratio of the capacitor length to the second external termination spacing distance can be greater than about 2, in some embodiments greater than about 3, in some embodiments greater than about 5, in some embodiments greater than about 7, in some embodiments greater than about 10, in some embodiments greater than about 20, in some embodiments greater than about 30, and in some embodiments greater than about 35.

In some embodiments, the first external termination spacing distance can be less than about 250 microns, in some embodiments less than about 200 microns, in some embodiments less than about 175 microns, in some embodiments less than about 150 microns, in some embodiments less than about 100 microns, in some embodiments less than about 75 microns, in some embodiments less than about 50 microns, in some embodiments less than about 40 microns, in some embodiments less than about 30 microns, and in some embodiments less than about 20 microns. Similarly, in some embodiments, the second external termination spacing distance can be less than about 250 microns, in some embodiments less than about 200 microns, in some embodiments less than about 175 microns, in some embodiments less than about 150 microns, in some embodiments less than about 100 microns, in some embodiments less than about 75 microns, in some embodiments less than about 50 microns, in some embodiments less than about 40 microns, in some embodiments less than about 30 microns, and in some embodiments less than about 20 microns. For example, in some embodiments the first external termination spacing distance and/or the second external termination spacing distance can be within a range of about 1 micron to about 250 microns, in some embodiments about 5 microns to about 200 microns, in some embodiments about 10 microns to about 150 microns, and in some embodiments about 15 microns to about 100 microns.

The capacitor can include an active electrode region having a plurality of active electrode layers. In some embodiments, the plurality of active electrode layers can include a first active electrode layer connected with the first external termination and a second active electrode layer connected with the second external termination. For example, the first active electrode layer can include a first active electrode connected with the first external termination, and the second active electrode layer can include a second active electrode connected with the second external termination. The first active electrode layer can overlap the second active electrode layer in the longitudinal direction. The overlap between the first active electrode layer and the second active electrode layer can provide capacitance between the first external termination and the second external termination. The first active electrode layer can overlap the second active electrode layer along an overlap distance. The overlap distance can be a significant portion of the length of the capacitor. A ratio of the overlap distance to the capacitor length can be greater than about 0.4, in some embodiments greater than about 0.5, and in some embodiments greater than about 0.6. For example, the overlap distance can range from about 0.4 to about 0.98, in some embodiments from about 0.5 to about 0.95, and in some embodiments from about 0.6 to about 0.9.

In some embodiments, the active electrode region contains an outermost active electrode layer, which can be the active electrode layer closest to the outer surface of the monolithic body. The outermost active electrode layer may be spaced apart from the outer surface by an outermost-active-to-surface distance. The outermost-active-to-surface distance can be relatively small such that a fringe effect capacitance is created between the active electrodes and the external terminations. The fringe effect capacitance can contribute to the excellent performance of the capacitor, particularly at lower frequencies of the capacitor's frequency range.

The monolithic body or capacitor may have a thickness along the Z-direction, and in some embodiments, a ratio of the thickness to the outermost-active-to-surface distance is 1.1 or more, in some embodiments is 2 or more, in some embodiments is 3 or more, in some embodiments is 5 or more, in some embodiments is 10 or more, in some embodiments is 20 or more, in some embodiments is 30 or more, in some embodiments is 40 or more, and in some embodiments is 50 or more.

In some embodiments, the outermost-active-to-surface distance may be 150 microns or less, in some embodiments 125 microns or less, in some embodiments 100 microns or less, in some embodiments 90 microns or less, in some embodiments 75 microns or less, in some embodiments 60 microns or less, in some embodiments 40 microns or less, in some embodiments 25 microns or less, in some embodiments 15 microns or less, in some embodiments 10 microns or less, and in some embodiments 5 microns or less. As examples, the outermost-active-to-surface distance may range from about 1 micron to about 150 microns, in some embodiments from about 5 to about 100 microns, in some embodiments from about 10 to about 90 microns, and in some embodiments from about 15 to about 50 microns.

The active electrode region may have an active electrode region thickness in the Z-direction. The active electrode region thickness may be defined between a lowest active electrode layer and a highest active electrode layer. A ratio of the capacitor thickness to the active electrode region thickness may range from about 1.1 to about 20, in some embodiments from about 1.5 to about 10, in some embodiments from about 1.7 to about 5.

In some embodiments, a first active electrode layer of the plurality of active electrode layers can include a first active electrode connected with the first external termination and a second active electrode connected with the second external termination. The second electrode can be co-planar with the first electrode. A second active electrode layer of the plurality of active electrode layers can include a third active electrode connected with the first external termination and a fourth active electrode connected with the second external termination. The third active electrode can be co-planar with the fourth active electrode. The first active electrode can overlap the fourth active electrode in the longitudinal direction. The overlap between the first active electrode and the fourth active electrode can provide capacitance between the first external termination and the second external termination. The first active electrode can overlap the fourth active electrode along an overlap distance. The overlap distance can be a significant portion of the length of the capacitor. A ratio of the overlap distance to the capacitor length can be greater than about 0.4, in some embodiments greater than about 0.5, and in some embodiments greater than about 0.6. For example, the overlap distance can range from about 0.4 to about 0.98, in some embodiments from about 0.5 to about 0.95, and in some embodiments from about 0.6 to about 0.9.

The active electrodes can have configurations that provide fringe effect capacitance between co-planar electrodes. This fringe effect capacitance can also contribute to the excellent high frequency performance of the device. For example, the first and second active electrodes can form a relatively small end gap, which can provide fringe effect capacitance between the active electrodes. For instance, an end gap distance can be formed in the longitudinal direction between the first active electrode and the second active electrode. In some embodiments, the end gap can be less than about 250 microns, in some embodiments less than about 150 microns, in some embodiments less than about 120 microns, and in some embodiments less than about 100 microns, and in some embodiments less than about 80 microns.

In some embodiments, the capacitor can include one or more shield electrode layers. The shield electrode layer(s) can have a variety of shapes and configurations. As an example, each shield electrode layer can include a pair of opposite, co-planar shield electrodes. In some embodiments, the shield electrodes can be generally square or rectangular. In other embodiments, the shield electrodes can have a step or notch.

The shield electrode layer(s) may be located within the monolithic body. The shield electrodes may be located between the active electrode region and an outer surface of the monolithic body, such as a bottom surface of the monolithic body or a top surface of the monolithic body. In some embodiments, the broadband multilayer ceramic capacitor may be free of shield electrodes above a plurality of active electrode layers in the Z-direction. In some embodiments, the broadband multilayer ceramic capacitor may be free of shield electrodes above a lowest electrode layer of the plurality of active electrode layers in the Z-direction.

The shield electrodes are generally spaced apart from the active electrodes by a shield-to-active distance such that the shield electrode region is spaced apart and/or distinct from the active electrode region. The active electrode layers of the plurality of active electrode layers may be uniformly spaced apart from each other in the Z-direction by an active electrode spacing distance, which is sometimes referred to as “drop.” The shield-to-active distance may be greater than the active electrode spacing distance. For instance, the shield-to-active distance may be 2 times or more greater than the active electrode spacing distance, in some embodiments 3 times or more greater, in some embodiments 4 times or greater, in some embodiments 5 times or greater, and in some embodiments 10 times or greater.

As examples, the active electrode spacing distance may range from about 0.1 microns to about 2 microns, and in some embodiments from about 0.2 to about 0.5 microns. The shield-to-active distance may range from 5 microns to about 80 microns, in some embodiments from about 10 microns to about 70 microns, in some embodiments from about 20 microns to about 60 microns, and in some embodiments from about 30 microns to about 50 microns.

The shield electrode region can include an outermost shield electrode layer, which can be the shield electrode layer closest to the outer surface of the monolithic body. The outermost shield electrode layer may be spaced apart from the outer surface by an outermost-shield-to-surface distance. The monolithic body or capacitor may have a thickness along the Z-direction, and in some embodiments, a ratio of the thickness to the outermost-shield-to-surface distance is 1.1 or more, in some embodiments is 2 or more, in some embodiments is 3 or more, in some embodiments is 5 or more, in some embodiments is 10 or more, and in some embodiments is 20 or more.

The shield electrode region may have a shield electrode region thickness in the Z-direction. The shield electrode region thickness may be defined between an outermost shield electrode of the shield electrode region and an innermost shield electrode of the shield electrode region with respect to the Z-direction. A ratio of the capacitor thickness to the shield electrode region thickness may range from about 1.1 to about 20, in some embodiments from about 1.5 to about 10, in some embodiments from about 1.7 to about 5.

In some embodiments, the capacitor may include a dielectric region between the active electrode region and a top of the capacitor and/or between the active electrode region and a bottom of the capacitor. For example, a first dielectric region may extend from the active electrode region to a first outer surface of the broadband multilayer ceramic capacitor, such as the top or bottom surface of the capacitor, and a second dielectric region may extend from the active electrode region to a second outer surface of the capacitor, such as the other of the top or bottom surface of the capacitor. As another example, the active electrode region may be located between a dielectric region and a shield electrode region in the Z-direction. As yet another example, a first dielectric region may extend from the active electrode region to an outer surface of the broadband multilayer ceramic capacitor, and a second dielectric region may extend from the active electrode region to a shield electrode region.

The dielectric region(s) may be free of active electrodes and/or shield electrodes. For instance, in some embodiments, the dielectric region(s) may include one or more floating electrodes and/or dummy electrode tabs. For example, a dielectric region between the active electrode region and a shield electrode region may include one or more dummy electrode tabs, which may aid in forming the external terminations. The dummy electrode tabs generally extend less than about 40% of a length of the capacitor from the respective ends of the capacitor. For instance, a first plurality of dummy electrode tabs may be connected with the first external termination, and a second plurality of dummy electrode tabs may be connected with the second external termination.

In some embodiments, the dielectric region(s) may be free of electrode layers that extend greater than 40% of a length of the capacitor, in some embodiments greater than 30% of the length of the capacitor, in some embodiments greater than 20% of the length of the capacitor, in some embodiments greater than 15% of the length of the capacitor, in some embodiments greater than 10% of the length of the capacitor, in some embodiments greater than 5% of the length of the capacitor, and in some embodiments greater than 2% of the length of the capacitor. However, in other embodiments, the dielectric region(s) may be free of all electrode layers.

The broadband multilayer ceramic capacitor may have a capacitor thickness in the Z-direction between the top surface and the bottom surface. The dielectric region may have a dielectric region thickness in the Z-direction. A ratio of the capacitor thickness to the dielectric region thickness may be about 1.1 or more, in some embodiments about 2 or more, in some embodiments about 5 or more, in some embodiments about 10 or more, in some embodiments about 20 or more, in some embodiments about 30 or more, in some embodiments about 40 or more, and in some embodiments about 50 or more. In some embodiments, the dielectric region extends between an outermost active electrode layer and an outer surface of the broadband multilayer ceramic capacitor such that the dielectric region thickness is the same as the outermost-active-to-surface distance.

The broadband multilayer ceramic capacitor may be part of, assembled with, and/or integrated into a device, e.g., a device operating over a broad range of frequencies. The capacitor may be configured for mounting to a mounting surface of the device. More particularly, the capacitor may be mounted to the mounting surface such that each active electrode layer of the plurality of active electrode layers of the capacitor extends parallel to the mounting surface. A capacitor mounted in such a horizontal orientation, where the active electrodes extend parallel to the mounting surface of the device, may perform better than a capacitor configured as described herein that is mounted in a vertical electrode orientation. For instance, the broadband multilayer ceramic capacitor mounted in a horizontal orientation may exhibit a lower insertion loss over a frequency range than the broadband multilayer ceramic capacitor mounted in a vertical orientation. As an example, the broadband multilayer ceramic capacitor mounted in a horizontal orientation may exhibit an insertion loss within a range of about 0.0 dB to about −0.8 dB over a frequency range of about 5 GHz to about 67 GHz, but the broadband multilayer ceramic capacitor mounted in a vertical orientation may exhibit an insertion loss within a range of about −1.5 dB to about −2.0 dB over a frequency range of about 5 GHz to about 67 GHz.

The sizing and spacing of the external terminations can be selectively configured in combination with the spacing of the active electrode region to the outer surface of the capacitor and/or the sizing of the capacitor to provide improved inductance and capacitance along a greater frequency range than previous capacitors. For example, the first external termination spacing distance and/or the second external termination spacing distance can be selected to provide an inductance loop that improves response characteristics of the capacitor across a first frequency range. The active electrode region configuration, such as the outermost-active-to-surface distance, can be selected to provide fringe effect capacitance that improves the response of the capacitor across a second frequency range that extends higher or lower than the first frequency range, or is the same as or is entirely distinct from the first frequency range. Further, the outermost-active-to-surface distance can be selected to provide an inductance loop that improves the response of the capacitor across a third frequency range that extends higher or lower than the first frequency range, or is the same as or is entirely distinct from the first frequency range; the third frequency range may be the same as or different from the second frequency range. For instance, a smaller first external termination spacing distance can improve performance over a first, higher frequency range, and a secondary capacitor can be formed between the outermost active electrode and terminations extending along an outer surface of the monolithic body that, with a smaller outermost-active-to-surface distance, improves performance over a second, lower frequency range.

The outermost-active-to-surface distance may define a cover layer between the electrodes and the outer surface of the capacitor that, in some embodiments, may be minimized to form a relatively thin cover layer, which can improve inductance and capacitance across both the first frequency range and the second frequency range, e.g., across all operational frequencies of the capacitor. The external termination spacing distance (such as the first external termination spacing distance and/or the second external termination spacing distance) may be minimized to improve inductance at higher frequencies in the operational frequency range of the capacitor. In at least some embodiments, a minimum external termination spacing distance in combination with a relatively small outermost-active-to-surface distance can provide better high frequency performance of the capacitor than either feature on its own and/or can improve performance of the capacitor over a broader frequency range than either feature on its own. Thus, one or more features as described herein can improve capacitor performance over at least a segment of a frequency band of the capacitor, while a combination of one or more features as described herein can provide better performance of the capacitor over the entire frequency band than any of the one or more features on their own.

The broadband multilayer ceramic capacitor as described herein may exhibit a low insertion loss across a broad range of frequencies. In general, the insertion loss is the loss of power through the capacitor and may be measured using any method generally known in the art. For example, the capacitor may exhibit an insertion loss that is greater than about −1.20 dB from about 1 GHz to about 67 GHz, in some embodiments greater than about −1.10 dB, in some embodiments greater than about −0.90 dB, and in some embodiments greater than about −0.80 dB. In some embodiments the capacitor may exhibit an insertion loss that is greater than about −0.60 dB from about 1 GHz to about 40 GHz, in some embodiments greater than about −0.50 dB, in some embodiments greater than about −0.45 dB, and in some embodiments greater than about −0.40 dB.

In some embodiments the capacitor may exhibit an insertion loss that is greater than about −0.30 dB at about 10 GHz, in some embodiments greater than about −0.25 dB at about 10 GHz, and in some embodiments greater than about −0.20 dB at about 10 GHz. The capacitor may exhibit an insertion loss that is greater than about −0.60 dB at about 20 GHz, in some embodiments greater than about −0.50 dB at about 20 GHz, in some embodiments greater than about −0.40 dB at about 20 GHz, and in some embodiments greater than about −0.30 dB. The capacitor may exhibit an insertion loss that is greater than about −0.40 dB at about 30 GHz, in some embodiments greater than about −0.35 dB at about 30 GHz, in some embodiments greater than about −0.30 dB at about 30 GHz, in some embodiments greater than about −0.25 dB at about 30 GHz, and in some embodiments greater than about −0.20 dB at about 30 GHz. The capacitor may exhibit an insertion loss that is greater than about −0.60 dB at about 40 GHz, in some embodiments greater than about −0.50 dB at about 40 GHz, in some embodiments greater than about −0.40 dB at about 40 GHz, and in some embodiments greater than about −0.30 dB at about 40 GHz. The capacitor may exhibit an insertion loss that is greater than about −1.20 dB at about 50 GHz, in some embodiments greater than about −0.90 dB at about 50 GHz, in some embodiments greater than about −0.80 dB at about 50 GHz, and in some embodiments greater than about −0.50 dB at about 50 GHz. The capacitor may exhibit an insertion loss that is greater than about −1.10 dB at about 60 GHz, in some embodiments greater than about −0.90 dB at about 60 GHz, in some embodiments greater than about −0.80 dB at about 60 GHz, and in some embodiments greater than about −0.60 dB at about 60 GHz.

In some embodiments, the broadband multilayer ceramic capacitor may exhibit an insertion loss that ranges from about −0.05 dB to about −0.40 dB from about 5 GHz to about 20 GHz, in some embodiments from about −0.10 dB to about −0.40 dB from about 10 GHz to about 20 GHz, in some embodiments from about −0.05 dB to about −0.40 dB from about 20 GHz to about 30 GHz, in some embodiments from about −0.05 dB to about −0.60 dB from about 30 GHz to about 40 GHz, in some embodiments from about −0.05 dB to about −1.20 dB from about 40 GHz to about 50 GHz, in some embodiments from about −0.05 dB to about −1.20 dB from about 50 GHz to about 60 GHz, and in some embodiments from about −0.05 dB to about −1.10 dB from about 60 GHz to about 67 GHz.

### I. EXAMPLE EMBODIMENTS

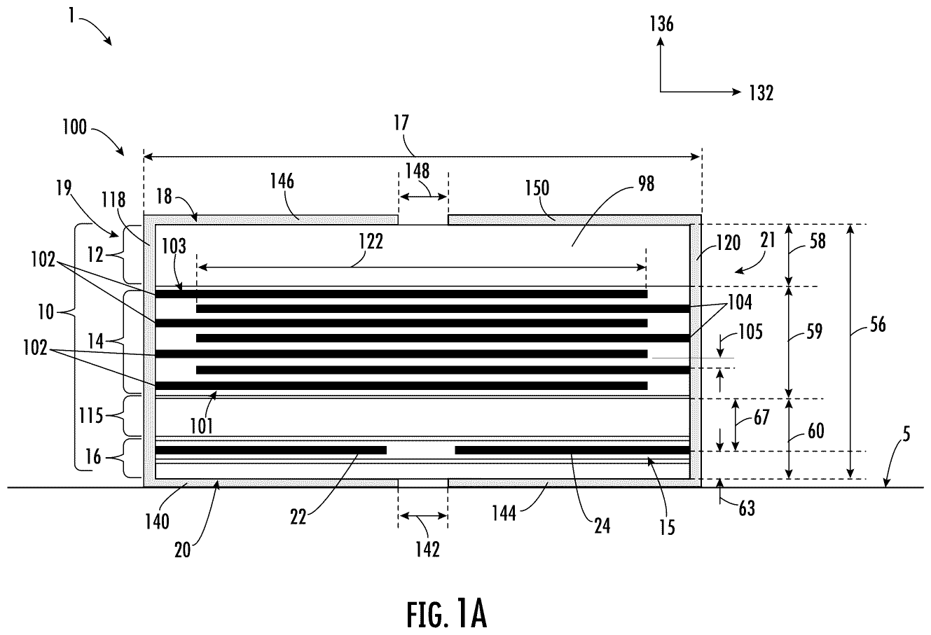

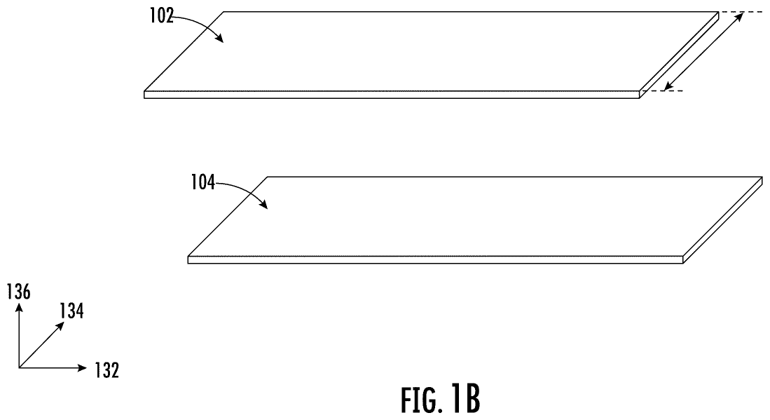

Turning to FIG. 1A, one embodiment of a broadband multilayer ceramic capacitor 100 is disclosed. FIG. 1A illustrates a schematic side cross-sectional view of one embodiment of the capacitor 100 according to aspects of the present disclosure. The multilayer capacitor 100 shown in the embodiment of FIG. 1A has a monolithic body 98 including a plurality of dielectric layers stacked in a Z-direction 136 and extending between a first end 19 and an opposite second end 21 in a longitudinal direction 132. A first external termination 118 is disposed along the first end 19 and a second external termination 120 is disposed along the second end 21. The first external termination 118 includes a first portion 140 extending along an outer surface of the monolithic body, such a bottom surface 20, and similarly, the second external termination 120 includes a first portion 144 extending along an outer surface of the monolithic body, such as the bottom surface 20. The first portion 140 of the first external termination 118 is spaced apart from the first portion 144 of the second external termination 120 by a first external termination spacing distance 142.

Likewise, in some embodiments, the first external termination 118 includes a second portion 146 extending along another outer surface of the monolithic body, such as a top surface 18, and the second external termination 120 includes a second portion 150 extending along another outer surface of the monolithic body, such as the top surface 18. The second portion 146 of the first external termination 118 is spaced apart from the second portion 150 of the second external termination 120 by a second external termination spacing distance 148. The top surface 18 of the monolithic body 98 may be opposite the bottom surface 20 along the Z-direction 136.

In some embodiments, the first external termination spacing distance 142 is the same as the second external termination spacing distance 148. In other embodiments, he first external termination spacing distance 142 and the second external termination spacing distance 148 are unequal to one another. For example, in some embodiments, the first external termination spacing distance 142 is greater than the second external termination spacing distance 148, and in other embodiments, the first external termination spacing distance 142 is less than the second external termination spacing distance 148.

In some embodiments, the first external termination spacing distance 142 is less than about 250 microns, in some embodiments less than about 200 microns, in some embodiments less than about 175 microns, in some embodiments less than about 150 microns, in some embodiments less than about 100 microns, in some embodiments less than about 75 microns, in some embodiments less than about 50 microns, in some embodiments less than about 40 microns, in some embodiments less than about 30 microns, and in some embodiments less than about 20 microns. In some embodiments, the second external termination spacing distance 148 is less than about 250 microns, in some embodiments less than about 200 microns, in some embodiments less than about 175 microns, in some embodiments less than about 150 microns, in some embodiments less than about 100 microns, in some embodiments less than about 75 microns, in some embodiments less than about 50 microns, in some embodiments less than about 40 microns, in some embodiments less than about 30 microns, and in some embodiments less than about 20 microns. For example, in some embodiments the first external termination spacing distance 142 and/or the second external termination spacing distance 148 is within a range of about 1 micron to about 250 microns, in some embodiments about 5 microns to about 200 microns, in some embodiments about 10 microns to about 150 microns, and in some embodiments about 15 microns to about 100 microns.

Further, the capacitor may have a capacitor length 17 extending in a longitudinal direction 132 between the first end 19 and the second end 21. A ratio of the capacitor length 17 to the first external termination spacing distance 142 and/or a ratio of the capacitor length 17 to the second external termination spacing distance 148 may be 2 or more, such as about 3 or more, about 5 or more, about 7 or more, about 10 or more, about 20 or more, about 30 or more, or about 35 or more.

As shown in FIG. 1A, the multilayer capacitor 100 may include a plurality of electrode regions 10 that are stacked in the Z-direction 136. The plurality of electrode regions 10 may include a dielectric region 12, an active electrode region 14, a shield electrode region 16, and a second or additional dielectric region 115. The active electrode region 14 may be located between the dielectric region 12 and the shield electrode region 16 in the Z-direction 136. The dielectric region 12 may extend from the active electrode region 14 to a top surface 18 of the broadband multilayer ceramic capacitor 100. The second or additional dielectric region 115 may extend from the active electrode region 14 to the shield electrode region 16.

The electrode regions 10 may include a plurality of dielectric layers. Some dielectric layers may include electrode layers formed thereon. In general, the thickness of the dielectric layers and the electrode layers is not limited and can be any thickness as desired depending on the performance characteristics of the capacitor. For instance, the thickness of the electrode layers can be, but is not limited to, being about 500 nm or greater, such as about 1 μm or greater, such as about 2 μm or greater, such as about 3 μm or greater, such as about 4 μm or greater to about 10 μm or less, such as about 5 μm or less, such as about 4 μm or less, such as about 3 μm or less, such as about 2 μm or less. For instance, the electrode layers may have a thickness of from about 1 μm to about 2 μm. In addition, in one embodiment, the thickness of the dielectric layer may be defined according to the aforementioned thickness of the electrode layers. Also, it should be understood that such thicknesses of the dielectric layers may also apply to the layers between any active electrode layers, and/or shield electrode layers, when present and as defined herein.

In general, the present invention provides a multilayer capacitor having a unique electrode arrangement and configuration that provides various benefits and advantages. In this regard, it should be understood that the materials employed in constructing the capacitor may not be limited and may be any as generally employed in the art and formed using any method generally employed in the art.

In general, the dielectric layers are typically formed from a material having a relatively high dielectric constant (K), such as from about 10 to about 40,000 in some embodiments from about 50 to about 30,000, and in some embodiments, from about 100 to about 20,000.

In this regard, the dielectric material may be a ceramic. The ceramic may be provided in a variety of forms, such as a wafer (e.g., pre-fired) or a dielectric material that is co-fired within the device itself.

Particular examples of the type of high dielectric material include, for instance, NPO (COG) (up to about 100), X7R (from about 3,000 to about 7,000), X7S, ZSU, and/or Y5V materials. It should be appreciated that the aforementioned materials are described by their industry-accepted definitions, some of which are standard classifications established by the Electronic Industries Alliance (EIA), and as such should be recognized by one of ordinary skill in the art. For instance, such material may include a ceramic. Such materials may include a pervoskite, such as barium titanate and related solid solutions (e.g., barium-strontium titanate, barium calcium titanate, barium zirconate titanate, barium strontium zirconate titanate, barium calcium zirconate titanate, etc.), lead titanate and related solid solutions (e.g., lead zirconate titanate, lead lanthanum zirconate titanate), sodium bismuth titanate, and so forth. In one particular embodiment, for instance, barium strontium titanate (“BSTO”) of the formula BaₓSr₁₋ₓTiO₃ may be employed, wherein x is from 0 to 1, in some embodiments from about 0.15 to about 0.65, and in some embodiments, from about from 0.25 to about 0.6. Other suitable perovskites may include, for instance, BaₓCa₁₋ₓTiO₃ where x is from about 0.2 to about 0.8, and in some embodiments, from about 0.4 to about 0.6, PbₓZr₁₋ₓTiO₃ (“PZT”) where x ranges from about 0.05 to about 0.4, lead lanthanum zirconium titanate (“PLZT”), lead titanate (PbTiO₃), barium calcium zirconium titanate (BaCaZrTiO₃), sodium nitrate (NaNO₃), KNbO₃, LiNbO₃, LiTaO₃, PbNb₂O₆, PbTa₂O₆, KSr(NbO₃) and NaBa₂(NbO₃)₅KHb₂PO₄. Still additional complex perovskites may include A[B1_{1/3}B2_{2/3}]O₃ materials, where A is BaₓSr₁₋ₓ (x can be a value from 0 to 1); B1 is Mg_{y}Zn_{1-y} (y can be a value from 0 to 1); B2 is Ta_{z}Nb_{1-z} (z can be a value from 0 to 1). In one particular embodiment, the dielectric layers may comprise a titanate.

The electrode layers may be formed from any of a variety of different metals as is known in the art. The electrode layers may be made from a metal, such as a conductive metal. The materials may include precious metals (e.g., silver, gold, palladium, platinum, etc.), base metals (e.g., copper, tin, nickel, chrome, titanium, tungsten, etc.), and so forth, as well as various combinations thereof. Sputtered titanium/tungsten (Ti/W) alloys, as well as respective sputtered layers of chrome, nickel and gold, may also be suitable. The electrodes may also be made of a low resistive material, such as silver, copper, gold, aluminum, palladium, etc. In one particular embodiment, the electrode layers may comprise nickel or an alloy thereof.

A plurality of first active electrode layers 102 and a plurality of second active electrode layers 104 may be arranged within the active electrode region 14 of the capacitor 100. More specifically, as shown in FIG. 1A, the active electrode region 14 may include first electrode layers 102 and second electrode layers 104 in an alternating arrangement. For instance, a plurality of first electrode layers 102 and a plurality of second electrode layers 104 may be arranged in an alternating, mirrored configuration. As further illustrated in FIG. 1A, the first active electrode layers 102 may be connected with the first external termination 118, and the second active electrode layers 104 may be connected with the second external termination 120.

Moreover, the first active electrode layers 102 can overlap the second active electrode layers along an overlap distance 122. Further, the side cross-sectional view of FIG. 1A illustrates a capacitor 100 having a total of four first electrode layers 102 and three second electrode layers 104. However, it should be understood that any number of electrode layers 102, 104 may be employed to obtain the desired capacitance for the desired application.

Referring to FIG. 1B, each active electrode layer 102, 104 may have an electrode width 126. More particularly, in the embodiment shown in FIG. 1B, each first active electrode layer 102 has an electrode width 126, and each second active electrode layer 104 has an electrode width 126. The electrode width 126 can impact the capacitance between, e.g., an outermost active electrode layer and the first portions 140, 144 of the first and second external terminations 118, 120 and/or an outermost active electrode layer and the second portions 146, 150 of the first and second external terminations 118, 120.

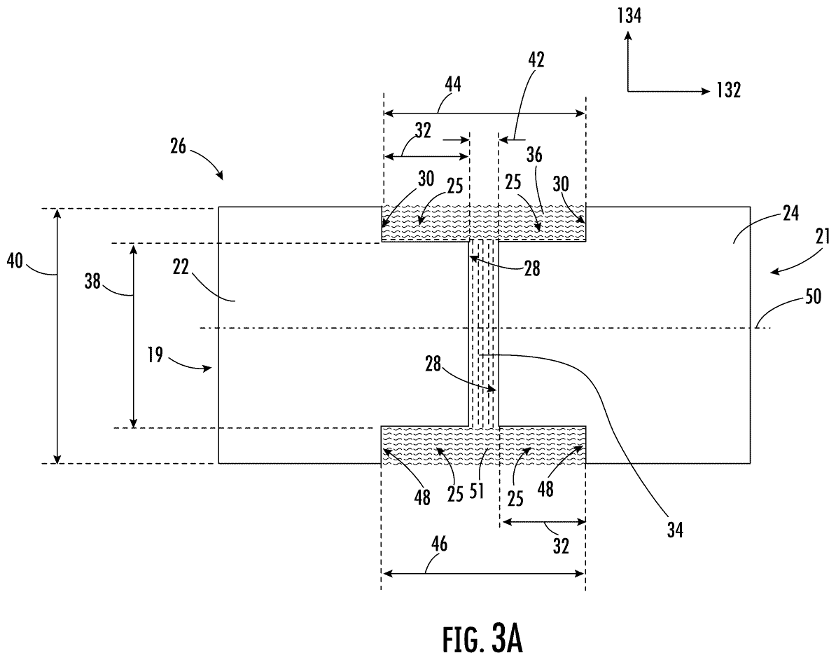

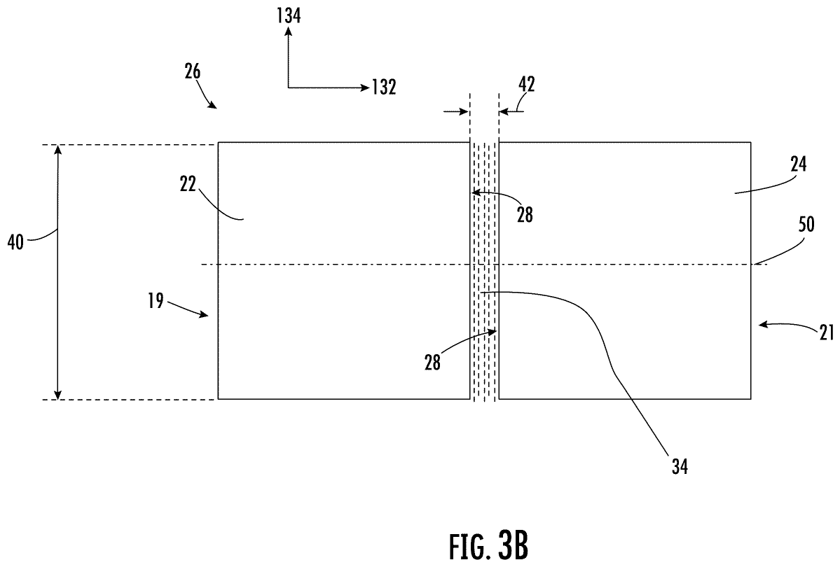

As further illustrated in FIG. 1A, the capacitor 100 may include one or more shield electrode layers 15 in the shield electrode region 16. The shield electrode layers 15 may have a variety of configurations, for example as described below with reference to FIGS. 3A and 3B, which illustrate shield electrode layers 15 may include a first shield electrode 22 and a second shield electrode 24.

The shield electrode region 16 may be located within the capacitor 100 between the active electrode region 14 and an outer surface of the monolithic body 98, such as between the active electrode region 14 and the top surface 18 and/or between the active electrode region 14 and the bottom surface 20. The shield electrodes layers 15 are generally spaced apart from the active electrode layers 102, 104 by a shield-to-active distance 67 such that the first shield electrodes 22 and second shield electrodes 24 are distinguished from the active electrodes. For example, the active electrode layers 102, 104 may be uniformly spaced apart from each other in the Z-direction 136 by an active electrode spacing distance 105, which is sometimes referred to as “drop.” The shield-to-active distance 67 may be greater than the active electrode spacing distance 105. For instance, the shield-to-active distance 67 may be two times or more greater than the active electrode spacing distance 105. As examples, the active electrode spacing distance 105 may range from about 0.5 microns to about 5 microns. The shield-to-active distance 67 may be greater than about 5 microns, in some embodiments greater than about 10 microns, in some embodiments greater than about 20 microns, and in some embodiments greater than about 30 microns.

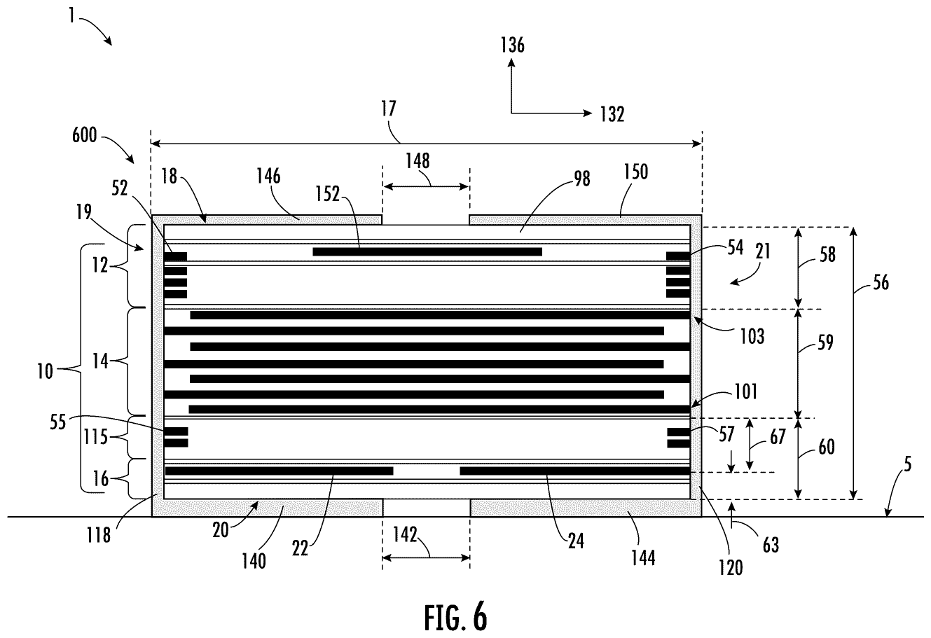

As shown, e.g., in FIG. 1A, in some embodiments, the capacitor 100 may be free of active electrode layers 102, 104 in an additional dielectric region 115 (e.g., a second dielectric region) between the active electrode region 14 and the shield electrode region 16 in the Z-direction 136. However, in other embodiments, the dielectric region 115 between the active electrode region 14 and the shield electrode region 16 may include one or dummy electrode tabs, for example as shown in FIG. 6, which may aid in forming the external terminations.

Referring to FIG. 1A, in some embodiments, the broadband multilayer ceramic capacitor 100 may have a capacitor thickness 56 in the Z-direction 136 between the top surface 18 and the bottom surface 20. The dielectric region 12 may have a dielectric region thickness 58 in the Z-direction 136. In some embodiments, a ratio of the capacitor thickness 56 to the dielectric region thickness 58 may be about 10 or more.

The active electrode region 14 may have an active electrode region thickness 59 in the Z-direction 136. The active electrode region 14 may be free of shield electrodes 22, 24 and/or may include only overlapping electrodes. The active electrode region thickness 59 may be defined between the lowest active electrode layer 101 and a highest active electrode layer 103 with respect to the Z-direction 136. A ratio of the capacitor thickness 56 to the active electrode region thickness 59 may range from about 1.1 to about 20.

Further, the region between the active electrodes 102, 104 and the bottom surface 20 of the capacitor 100, which region is formed by the second or additional dielectric region 115 and the shield electrode region 16 in the embodiment of FIG. 1A, may be relatively thin. More specifically, an outermost-active-to-surface distance 60 between an outermost active electrode layer and an outer surface of the monolithic body 98 (such as between the lowest active electrode layer 101 and the bottom surface 20 as shown in FIG. 1A) is relatively small or may be minimized to form a relatively thin cover layer between the active electrodes 102, 104 and the outer surface of the monolithic body 98. For instance, a ratio of the capacitor thickness 56 to the outermost-active-to-surface distance 60 may be greater than about 2. For example, in some embodiments, the ratio of the capacitor thickness 56 to the outermost-active-to-surface distance 60 may be 1.1 or more, in some embodiments 2 or more, in some embodiments 3 or more, in some embodiments 5 or more, in some embodiments 10 or more, in some embodiments 20 or more, in some embodiments 30 or more, in some embodiments 40 or more, and in some embodiments 50 or more. Moreover, in some embodiments, the outermost-active-to-surface distance 60 may be 150 microns or less, in some embodiments 125 microns or less, in some embodiments 100 microns or less, in some embodiments 90 microns or less, in some embodiments 75 microns or less, in some embodiments 60 microns or less, in some embodiments 40 microns or less, in some embodiments 25 microns or less, in some embodiments 15 microns or less, in some embodiments 10 microns or less, and in some embodiments 5 microns or less. As examples, the outermost-active-to-surface distance 60 may range from about 1 micron to about 150 microns, in some embodiments from about 5 to about 100 microns, in some embodiments from about 10 to about 90 microns, and in some embodiments from about 15 to about 50 microns.

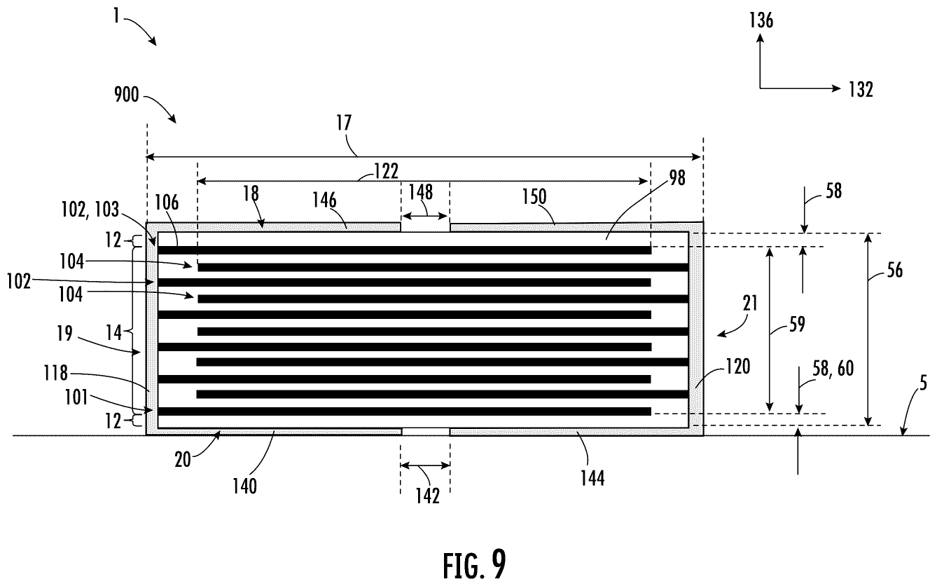

As shown in the embodiment of FIG. 1A, the cover layer or outermost-active-to-surface distance 60 includes the shield electrode region 16 and the second or additional dielectric region 115. In some embodiments, the dielectric region 12 extends between an outermost active electrode layer and an outer surface of the broadband multilayer ceramic capacitor such that the dielectric region 12 defines a cover layer and the dielectric region thickness 58 is the same as the outermost-active-to-surface distance 60. For example, referring to FIG. 9, the illustrated broadband multilayer ceramic capacitor 900 includes a first dielectric region 12 extending from the active electrode region 14 to the top surface 18, and a second dielectric region 12 extending from the active electrode region 14 to the bottom surface 20, with the dielectric region thickness 58 of the second dielectric region 12 being the same as the outermost-active-to-surface distance 60.

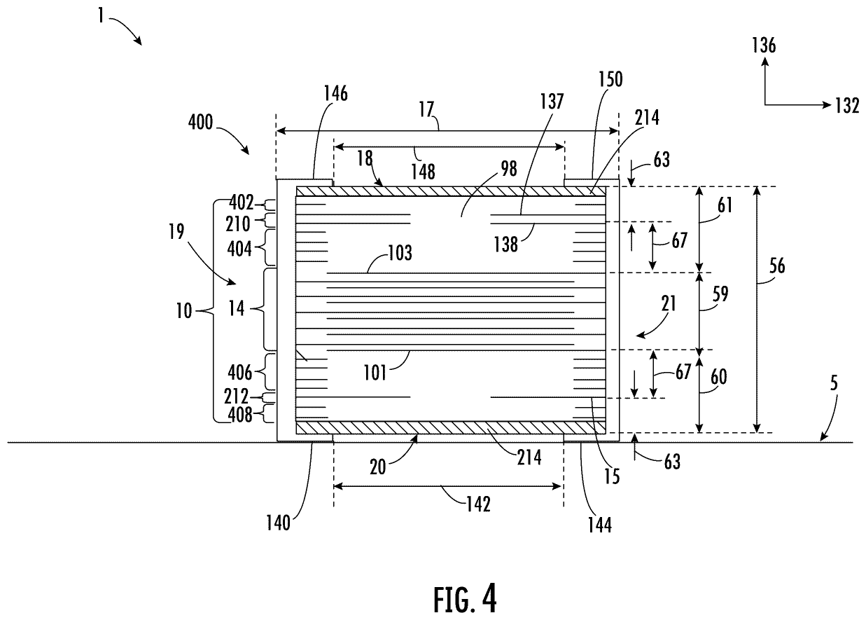

In some embodiments, an outermost-shield-to-surface distance 63 may be defined as a distance between the shield electrodes 22, 24 and an outer surface of the capacitor 100, such as the bottom surface 20 of the capacitor 100 as shown in FIG. 1A. If multiple shield electrode layers 15 are included, the outermost-shield-to-surface distance 63 may be defined as the distance between the outermost shield electrode layer 137 (FIG. 4) and the outer surface, which may be, e.g., the top surface 18 for a shield electrode region 16 between the top surface 18 and the active electrode region 14 or the bottom surface 20 for a shield electrode region 16 between the active electrode region 14 and the bottom surface 20. A ratio of the capacitor thickness 56 to the outermost-shield-to-surface distance 63 may be greater than about 2. For example, in some embodiments, the ratio of the capacitor thickness 56 to the outermost-shield-to-surface distance 63 may be 1.1 or more, in some embodiments 2 or more, in some embodiments 3 or more, in some embodiments 5 or more, in some embodiments 10 or more, and in some embodiments 20 or more.

As previously described, the shield electrodes 22, 24 may be spaced apart from the active electrode layers 102, 104 by a shield-to-active distance 67. In the embodiment of FIG. 1A, the shield-to-active distance 67 is defined between the lowest active electrode 101 and the shield electrode layer 15 closest to the lowest active electrode 101 in the Z-direction 136. In embodiments including more than one shield electrode layer 15, such as shown in FIG. 4, the shield-to-active distance 67 is defined between the innermost shield electrode layer 138 and the active electrode layer 102, 104 closest to the innermost shield electrode layer 138. A ratio of the shield-to-active distance 67 to the outermost-shield-to-surface distance 63 may range from about 1 to about 20, in some embodiments from about 2 to about 10, and in some embodiments from about 3 to about 5.

In general, regarding embodiments discussed herein, the first and second external terminations 118, 120 may be formed from any of a variety of different materials as is known in the art. For instance, the external terminations 118, 120 may be made from a metal, such as a conductive metal. The external termination materials may include precious metals (e.g., silver, gold, palladium, platinum, etc.), base metals (e.g., copper, tin, nickel, chrome, titanium, tungsten, etc.), and so forth, as well as various combinations thereof. In one particular embodiment, the external terminations 118, 120 may comprise copper or an alloy thereof.

The external terminations 118, 120 can be formed using any method generally known in the art. The external terminations 118, 120 may be formed using techniques such as sputtering, painting, printing, electroless plating or fine copper terminal (FCT), electroplating, plasma deposition, propellant spray/air brushing, and so forth.

In one embodiment, the external terminations 118, 120 may be formed such that the external terminations 118, 120 are relatively thick. For instance, the external terminations 118, 120 may be formed by applying a thick film stripe of a metal to exposed portions of electrode layers (e.g., by dipping the capacitor in a liquid external termination material). Such metal may be in a glass matrix and may include silver or copper. As an example, such strip may be printed and fired onto the capacitor. Thereafter, additional plating layers of metal (e.g., nickel, tin, solder, etc.) may be created over the terminal strips such that the capacitor is solderable to a substrate. Such application of thick film stripes may be conducted using any method generally known in the art (e.g., by a terminal machine and printing wheel for transferring a metal-loaded paste over the exposed electrode layers).

The thick-plated external terminations 118, 120 may have an average thickness of about 150 μm or less, such as about 125 μm or less, such as about 100 μm or less, such as about 80 μm or less. The thick-plated external terminations 118, 120 may have an average thickness of about 25 μm or more, such as about 35 μm or more, such as about 50 μm or more, such as about 75 or more μm. For instance, the thick-plated external terminations 118, 120 may have an average thickness of from about 25 μm to about 150 μm, such as from about 35 μm to about 125 μm, such as from about 50 μm to about 100 μm.

In another embodiment, the external terminations 118, 120 may be formed such that each external termination is a thin-film plating of a metal. Such thin-film plating can be formed by depositing a conductive material, such as a conductive metal, on an exposed portion of an electrode layer. For instance, a leading edge of an electrode layer may be exposed such that it may allow for the formation of a plated terminal.

The thin-plated external terminations 118, 120 may have an average thickness of about 50 μm or less, such as about 40 μm or less, such as about 30 μm or less, such as about 25 μm or less. The thin-plated external terminations 118, 120 may have an average thickness of about 5 μm or more, such as about 10 μm or more, such as about 15 μm or more. For instance, the external terminations 118, 120 may have an average thickness of from about 5 μm to about 50 μm, such as from about 10 μm to about 40 μm, such as from about 15 μm to about 30 μm, such as from about 15 μm to about 25 μm.

In general, the external terminations 118, 120 may comprise a plated terminal. For instance, the external terminations 118, 120 may comprise an electroplated terminal, an electroless plated terminal, or a combination thereof. For instance, an electroplated terminal may be formed via electrolytic plating. An electroless plated terminal may be formed via electroless plating.

When multiple layers constitute the external termination, the external termination may include an electroplated terminal and an electroless plated terminal. For instance, electroless plating may first be employed to deposit an initial layer of material. The plating technique may then be switched to an electrochemical plating system, which may allow for a faster buildup of material.

When forming the plated terminations 118, 120 with either plating method, a leading edge of the lead tabs of the electrode layers that is exposed from the main body of the capacitor is subjected to a plating solution, e.g., by dipping the capacitor into the plating solution.

The plating solution contains a conductive material, such as a conductive metal, to form the plated termination, i.e., the conductive material is employed to form the plated terminal. Such conductive material may be any of the aforementioned materials or any as generally known in the art. For instance, the plating solution may be a nickel sulfamate bath solution or other nickel solution such that the plated layer and external termination comprise nickel. Alternatively, the plating solution may be a copper acid bath or other suitable copper solution such that the plated layer and external termination comprise copper.

Additionally, it should be understood that the plating solution may comprise other additives as generally known in the art. For instance, the additives may include other organic additives and media that can assist in the plating process. Additionally, additives may be employed in order to employ the plating solution at a desired pH. In one embodiment, resistance-reducing additives may be employed in the solutions to assist with complete plating coverage and bonding of the plating materials to the capacitor and exposed leading edges of the lead tabs.

The capacitor may be exposed, submersed, or dipped in the plating solution for a predetermined amount of time. Such exposure time is not necessarily limited but may be for a sufficient amount of time to allow for enough plating material to deposit in order to form the plated terminal. In this regard, the time should be sufficient for allowing the formation of a continuous connection among the desired exposed, adjacent leading edges of lead tabs of a given polarity of the respective electrode layers within a set of alternating dielectric layers and electrode layers.

In general, the difference between electrolytic plating and electroless plating is that electrolytic plating employs an electrical bias, such as by using an external power supply. Typically, the electrolytic plating solution may be subjected to a high current density range, for example, ten to fifteen amp/ft² (rated at 9.4 volts). A connection may be formed with a negative connection to the capacitor requiring formation of the plated terminals and a positive connection to a solid material (e.g., Cu in Cu plating solution) in the same plating solution. That is, the capacitor is biased to a polarity opposite that of the plating solution. Using this method, the conductive material of the plating solution is attracted to the metal of the exposed leading edge of the lead tabs of the electrode layers.

Prior to submersing or subjecting the capacitor to a plating solution, various pretreatment steps may be employed. These steps may be conducted for a variety of purposes, including to catalyze, to accelerate, and/or to improve the adhesion of the plating materials to the leading edges of the lead tabs.

Additionally, prior to plating or any other pretreatment steps, an initial cleaning step may be employed. This step may be employed to remove any oxide buildup that forms on the exposed lead tabs of the electrode layers. This cleaning step may be particularly helpful to assist in removing any buildup of nickel oxide when the internal electrodes or other conductive elements are formed of nickel. Component cleaning may be effected by full immersion in a preclean bath, such as one including an acid cleaner. In one embodiment, exposure may be for a predetermined time, such as on the order of about 10 minutes. Cleaning may also alternatively be effected by chemical polishing or harperizing steps.

In addition, a step to activate the exposed metallic leading edges of the lead tabs of the electrode layers may be performed to facilitate depositing of the conductive materials. Activation can be achieved by immersion in palladium salts, photo patterned palladium organometallic precursors (via mask or laser), screen printed or ink-jet deposited palladium compounds or electrophoretic palladium deposition. It should be appreciated that palladium-based activation is presently disclosed merely as an example of activation solutions that often work well with activation for exposed tab portions formed of nickel or an alloy thereof. However, it should be understood that other activation solutions may also be utilized.

Also, in lieu of or in addition to the aforementioned activation step, the activation dopant may be introduced into the conductive material when forming the electrode layers of the capacitor. For instance, when the electrode layer comprises nickel and the activation dopant comprises palladium, the palladium dopant may be introduced into the nickel ink or composition that forms the electrode layers. Doing so may eliminate the palladium activation step. It should be further appreciated that some of the above activation methods, such as organometallic precursors, also lend themselves to co-deposition of glass formers for increased adhesion to the generally ceramic body of the capacitor. When activation steps are taken as described above, traces of the activator material may often remain at the exposed conductive portions before and after terminal plating.

Additionally, post-treatment steps after plating may also be employed. Such steps may be conducted for a variety of purposes, including enhancing and/or improving adhesion of the materials. For instance, a heating (or annealing) step may be employed after performing the plating step. Such heating may be conducted via baking, laser subjection, UV exposure, microwave exposure, arc welding, etc.

As indicated herein, the external termination may include at least one plating layer. In one embodiment, the external termination may comprise only one plating layer. However, it should be understood that the external terminations may comprise a plurality of plating layers. For instance, the external terminations may comprise a first plating layer and a second plating layer. In addition, the external terminations may also comprise a third plating layer. The materials of these plating layers may be any of the aforementioned and as generally known in the art.

For instance, one plating layer, such as a first plating layer, may comprise copper or an alloy thereof. Another plating layer, such as a second plating layer, may comprise nickel or an alloy thereof. Another plating layer, such as a third plating layer, may comprise tin, lead, gold, or a combination of materials, such as an alloy. Alternatively, an initial plating layer may include nickel, followed by plating layers of tin or gold. In another embodiment, an initial plating layer of copper may be formed and then a nickel layer.

In one embodiment, an initial or first plating layer may be a conductive metal (e.g., copper). This area may then be covered with a second layer containing a resistor-polymeric material for sealing. The area may then be polished to selectively remove resistive polymeric material and then plated again with a third layer containing a conductive, metallic material (e.g., copper).

The aforementioned second layer above the initial plating layer may correspond to a solder barrier layer, for example a nickel-solder barrier layer. In some embodiments, the aforementioned layer may be formed by electroplating an additional layer of metal (e.g., nickel) on top of an initial electrolessly or electrolytically plated layer (e.g., plated copper). Other exemplary materials for the aforementioned solder barrier layer include nickel-phosphorus, gold, and silver. A third layer on the aforementioned solder-barrier layer may in some embodiments correspond to a conductive layer, such as plated Ni, Ni/Cr, Ag, Pd, Sn, Pb/Sn or other suitable plated solder.

In addition, a layer of metallic plating may be formed followed by an electroplating step to provide a resistive alloy or a higher resistance metal alloy coating, for example, electroless Ni—P alloy over such metallic plating. It should be understood, however, that it is possible to include any metal coating as those of ordinary skill in the art will understand from the complete disclosure herewith.

It should be appreciated that any of the aforementioned steps can occur as a bulk process, such as barrel plating, fluidized bed plating, and/or flow-through plating terminal processes, all of which are generally known in the art. Such bulk processes enable multiple components to be processed at once, providing an efficient and expeditious termination process. This is a particular advantage relative to conventional termination methods, such as the printing of thick-film terminations that require individual component processing.

In some embodiments, a combination of external termination configurations may be used for the first external termination 118 and/or the second external termination 120. For example, in some embodiments, the first and second external terminations 118, 120 may be a combination of FCT (fine copper termination) and thick film terminations. For instance, an FCT may be applied on each end of the monolithic body 98, and a thick film termination may be applied over each FCT termination. Other combinations of termination formation techniques and/or configurations may be used as well.

As described herein, the formation of the external terminations is generally guided by the position of the exposed leading edges of the lead tabs of the electrode layers. Such phenomena may be referred to as “self-determining” because the formation of the external plated terminals is determined by the configuration of the exposed conductive metal of the electrode layers at the selected peripheral locations on the capacitor. In some embodiments, the capacitor may include “dummy tabs” to provide exposed conductive metal along portions of the monolithic body of the capacitor that does not include other electrodes (e.g., active or shield electrodes). In some embodiments, one or more “dummy tabs,” “dummy electrodes,” anchor tabs, and/or anchor electrodes may, e.g., be added features for a nucleate function occurring such as during an FCT (fine copper termination, electroless plating) process. Such dummy or anchor tabs or electrodes may be positioned internally or externally relative to the monolithic component to nucleate metallized plating material to form external plated terminals in an FCT process.

It should be appreciated that additional technologies for forming capacitor terminals may also be within the scope of the present technology. Exemplary alternatives include, but are not limited to, formation of terminals by plating, magnetism, masking, electrophoretics/electrostatics, sputtering, vacuum deposition, printing, or other techniques for forming both thick-film or thin-film conductive layers.

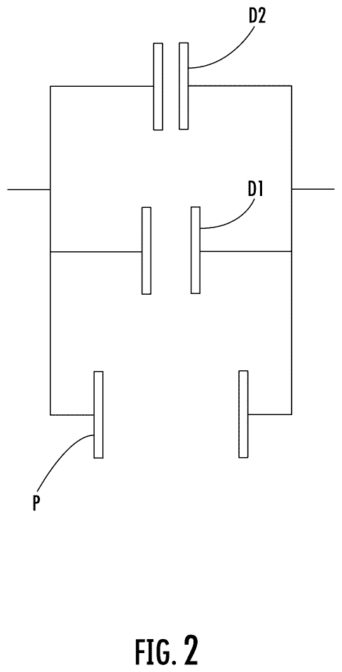

FIG. 2 illustrates a circuit diagram of the capacitor 100 illustrated in FIG. 1A. It will be appreciated that various capacitive elements may be defined within the capacitor 100 and that the dimensions of the various gaps and/or spacing distances may be selectively designed to achieve desired respective capacitance values for the capacitive elements of the capacitor 100. More specifically, the configuration of the capacitor and various parameters such as the number of electrode layers, the surface area of the overlapping central portions of electrode pairs, the distance separating electrodes, the dielectric constant of the dielectric material, etc., may be selected to achieve desired capacitance values. Nevertheless, the capacitor as disclosed herein may include an array of combined series and parallel capacitors to provide effective broadband performance.

In one exemplary ultra-broadband capacitor embodiment illustrated in FIG. 2, a primary capacitor P generally corresponds to a relatively large capacitance adapted for operation at a generally lower frequency range, such as on the order of between about several kilohertz (kHz) to about 200 megahertz (MHz), while secondary capacitors D1 and D2 may generally correspond to relatively smaller value capacitors configured to operate at a relatively higher frequency range, such as on the order of between about 200 megahertz (MHz) to many gigahertz (GHz). For example, the secondary capacitor D1 may correspond to a smaller value capacitor than the primary capacitor P and may be configured to operate at a higher frequency than the primary capacitor P, and the secondary capacitor D2 may correspond to a smaller value capacitor than the secondary capacitor D1 and may be configured to operate at a higher frequency than the secondary capacitor D1. As described above, the primary capacitor P, the secondary capacitor D1, and the secondary capacitor D2 each may be formed by a capacitive element defined by the capacitor 100 (or the various embodiments multilayer capacitors described herein), with the capacitance value of each capacitor P, D1, D2 determined based on the selected value of one or more dimensions that are described herein. For instance, a thinner cover layer or outermost-active-to-surface distance 60 may be selected to provide a capacitance value to improve low frequency performance of the capacitor, while a smaller first external termination spacing distance 142 may be selected to provide a capacitance value to improve high frequency performance of the capacitor.

FIG. 3A illustrates a shield electrode layer 26, which may be included within the shield electrode region 16 (illustrated in FIG. 1A) within the monolithic body of the capacitor 100. As indicated above, the first shield electrode 22 may be parallel with the longitudinal direction 132 (e.g., parallel with the top and bottom surfaces 18, 20 illustrated in FIG. 1A). The first shield electrode 22 may have a first longitudinal edge 28 aligned with the lateral direction 134 and facing away from the first external termination 118 (shown in FIG. 1A) and the first end 19. The first shield electrode 22 may have a second longitudinal edge 30 aligned with the lateral direction 134 and facing away from the first external termination 118 (shown in FIG. 1A) and the first end 19. The second longitudinal edge 30 may be offset in the longitudinal direction 132 from the first longitudinal edge 28 by a shield electrode offset distance 32 to define a step 25.

The second shield electrode 24 may be connected with the second external termination 120 (illustrated in FIG. 1A) and the second end 21. The second shield electrode 24 may be approximately aligned with the first shield electrode 22 in the Z-direction 136 (illustrated in FIG. 1A). The second shield electrode 24 may have a similar configuration to the first shield electrode 22. For example, the second shield electrode 24 may have a first longitudinal edge 28 aligned with the lateral direction 134 and facing away from the second external termination 120 (illustrated in FIG. 1A) and the second end 21. The second shield electrode 24 may have a second longitudinal edge 30 aligned with the lateral direction 134 and facing away from the second external termination 120 (illustrated in FIG. 1A) and the second end 21. The second longitudinal edge 30 of the second shield electrode 24 may be offset from the first longitudinal edge 28 of the second shield electrode 24 in the longitudinal direction 132 by the shield electrode offset distance 32 to define a step 25.

A first shield capacitive region 34 may be formed between the first longitudinal edges 28 of the first and second shield electrodes 22, 24. A second shield capacitive region 36 may be formed between the second longitudinal edges 30 of the first and second shield electrodes 22, 24. In some embodiments, a width 38 of the first longitudinal edge 28 in the lateral direction 134 may be less than a width 40 of the first shield electrode 22 in the lateral direction 134.

A first shield gap distance 42 may be formed in the longitudinal direction 132 between the first longitudinal edge 28 of the first shield electrode 22 and the first longitudinal edge 28 of the second shield electrode 24. A second shield gap distance 44 may be formed in the longitudinal direction 132 between the second lateral edge 30 of the first shield electrode 22 and the second lateral edge 30 of the second shield electrode 22.

In some embodiments, a third shield gap distance 46 may be formed between a third longitudinal edge 48 of the first shield electrode 22 and a third longitudinal edge 48 of the second shield electrode 24. A third shield capacitive region 51 may be formed between the third longitudinal edges 48 of the first and second shield electrodes 22, 24. In some embodiments, the third shield gap distance 46 may be approximately equal to the second shield gap distance 44 such that the third shield capacitive region 51 may be substantially similar in size and shape to the second shield capacitive region 36. For example, in some embodiments the first shield electrode 22 and/or second shield electrode 24 may be symmetric about a longitudinal centerline 50 that extends in the longitudinal direction 132.

In other embodiments, however, the third shield gap distance 46 may be greater than or less than the second shield gap distance 44 such that the third shield capacitive region 51 is differently sized and/or shaped than the second shield capacitive region 36 and produces a different capacitance than the second capacitive region.

It should be understood that, in some embodiments, one or more of the shield electrodes 22, 24 may be rectangular. In other words, the shield electrode offset distance 32 may be zero or approximately zero such that the first longitudinal edge 28 and second longitudinal edge 30 are aligned or approximately aligned.

FIG. 3B illustrates another embodiment of a shield electrode layer 26, which may be included within the shield electrode region 16 (illustrated in FIG. 1A) within the monolithic body of the capacitor 100. A first shield electrode 22 may be parallel with the longitudinal direction 132 (e.g., parallel with the top and bottom surfaces 18, 20 illustrated in FIG. 1A). The first shield electrode 22 may be connected with the first external termination 118 (illustrated in FIG. 1A) and the first end 19. The first shield electrode 22 may have a generally square or rectangular shape. The second shield electrode 24 may be connected with the second external termination 120 (illustrated in FIG. 1A) and the second end 21. The second shield electrode 24 may be approximately aligned with the first shield electrode 22 in the Z-direction 136 (illustrated in FIG. 1A). The second shield electrode 24 may have a similar configuration to the first shield electrode 22.

A single shield capacitive region 34 may be formed between the first shield electrode 22 and the second shield electrode 24. More particularly, in the embodiment of FIG. 3B, the first shield electrode 22 has a longitudinal edge 28 aligned with the lateral direction 134 and facing away from the first external termination 118 (shown in FIG. 1A) and the first end 19. Similarly, the second shield electrode 24 has a longitudinal edge 28 aligned with the lateral direction 134 and facing away from the second external termination 120 (shown in FIG. 1A) and the second end 21. A shield gap distance 42 may be formed in the longitudinal direction 132 between the longitudinal edge 28 of the first shield electrode 22 and the longitudinal edge 28 of the second shield electrode 24. As shown in FIG. 3B, the capacitive region 34 is formed in the gap between the longitudinal edges 28 of the first and second shield electrodes 22, 24.

Referring back to FIG. 1A, the capacitor 100 may be part of a device 1 that includes a mounting surface 5. As shown in FIG. 1A, in some embodiments, the capacitor 100 is configured for mounting to the mounting surface 5, which may be any surface known in the art to which a capacitor may be mounted or coupled. As further shown in FIG. 1A, the capacitor 100 is mounted to the mounting surface 5 such that each active electrode layer 102, 104 of the plurality of active electrode layers 102, 104 of the capacitor 100 extends parallel to the mounting surface. As described elsewhere herein, a capacitor 100 in a horizontal orientation as shown in the Figures, where the active electrodes extend parallel to the mounting surface 5, may perform better than a capacitor configured as described herein that is mounted in a vertical electrode orientation.

Referring to FIG. 4, a schematic side cross-sectional view is provided of another embodiment of a broadband multilayer capacitor. Like the capacitor 100 illustrated in FIG. 1A, the multilayer capacitor 400 shown in the embodiment of FIG. 4 includes a first external terminal 118 disposed along a first end 19 and a second external terminal 120 disposed along a second end 21 that is opposite the first end 19 in the longitudinal direction 132. Also as described with respect to the capacitor 100, the capacitor 400 may include a plurality of dielectric layers and a plurality of electrode layers, wherein the electrode layers are interleaved in an opposed and spaced apart relation with a dielectric layer located between each adjacent electrode layer.

More particularly, in the embodiment of FIG. 4, the capacitor 400 has a monolithic body 98 including a plurality of dielectric layers stacked in the Z-direction 136 and extending between the first end 19 and the opposite second end 21, with the first external termination 118 disposed along the first end 19 and the second external termination 120 disposed along the second end 21. The first external termination 118 includes a first portion 140 extending along an outer surface of the monolithic body, such as the bottom surface 20, and similarly, the second external termination 120 includes a first portion 144 extending along an outer surface of the monolithic body, such as the bottom surface 20. The first portion 140 of the first external termination 118 is spaced apart from the first portion 144 of the second external termination 120 by a first external termination spacing distance 142. Likewise, in some embodiments, the first external termination 118 includes a second portion 146 extending along another outer surface of the monolithic body, such as the top surface 18, and the second external termination 120 includes a second portion 150 extending along another outer surface of the monolithic body, such as the top surface 18. The second portion 146 of the first external termination 118 is spaced apart from the second portion 150 of the second external termination 120 by a second external termination spacing distance 148. The first external termination spacing distance 142 and/or the second external termination spacing distance 148 may be configured as described with respect to the capacitor 100 shown in FIG. 1A, e.g., the first external termination spacing distance 142 may be the same as or different from the second external termination spacing distance 148 and/or may be within one of the specified ranges.

In addition, as indicated above, the capacitor 400 may include a shield electrode. For example, as illustrated in FIG. 4, the multilayer capacitor 400 may include a first shield region 210 and a second shield region 212, and each of the shield regions 210, 212 may include one or more shield electrode layers 26, e.g., as described above with respect to FIGS. 3A and 3B. In some embodiments, the shield regions 210, 212 may be spaced apart from the active electrode region 14 by a dielectric region (for instance, one not containing any electrode layers).

A shield electrode region thickness 61 may be defined in the Z-direction 136. The shield electrode region thickness 61 may be defined between an outer surface of the capacitor 100 (such as the top surface 18 as shown in FIG. 4) and an outermost electrode layer of the plurality of active electrode layers 102, 104 (such as the highest electrode layer 103 as shown in FIG. 4). A ratio of the capacitor thickness 56 to the shield electrode region thickness 61 may range from about 1.1 to about 20.

The shield electrode layers 26 may have a first shield electrode configuration, in which each shield electrode 22, 24 is generally rectangular, e.g., as described with respect to FIG. 3B. In other embodiments, the shield electrode layers 26 may have a second shield electrode configuration, in which the shield electrodes 22, 24 include a step 25, for example as explained above with reference to the electrodes of FIG. 3A.

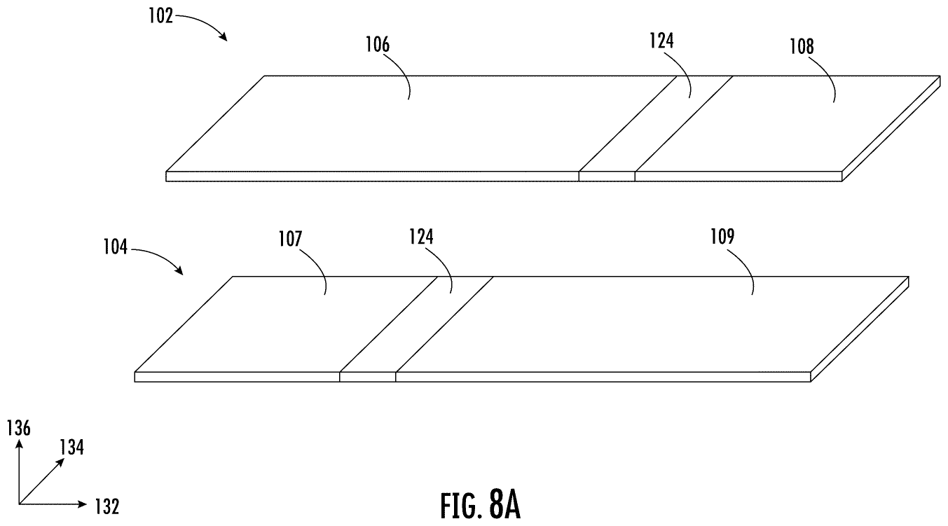

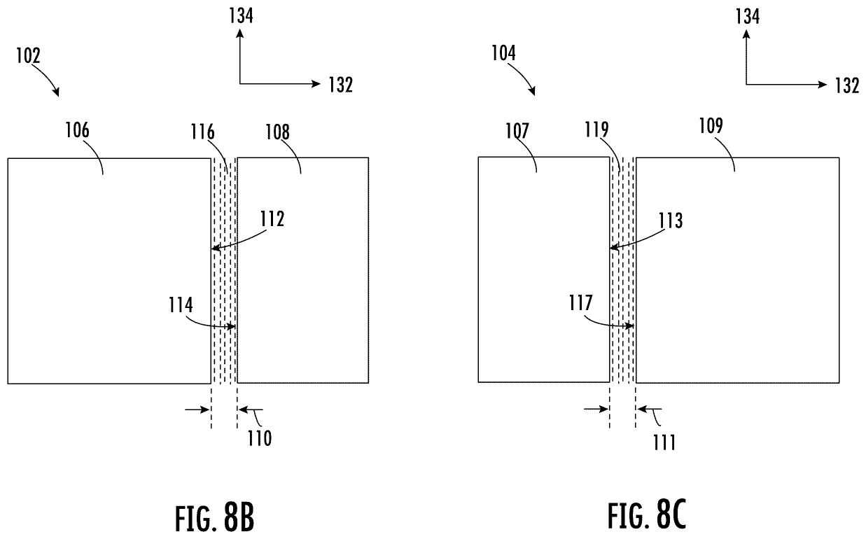

As previously described, an active electrode 14 region may be disposed between the first and second shield regions 210, 212. The active electrode region 14 may include a plurality of alternating active electrode layers 102, 104, which, for example, may be configured as explained with reference to FIG. 1A or, in other embodiments, FIGS. 8A through 8C. Additionally, a pair of ceramic covers 214 may be disposed along the top and/or bottom surfaces of the capacitor 400. The ceramic covers 214 may include a dielectric material that is the same as or similar to the dielectric material of the plurality of dielectric layers.

Referring still to FIG. 4, in some embodiments, the multilayer capacitor 400 may also include anchor electrode regions 402, 404, 406, and/or 408. For example, the multilayer capacitor 400 may include a first anchor electrode region 404 on top of the active electrode region 14. Further, the first shield electrode region 210 containing a shield electrode layer 26 may be positioned above, such as on top of, the first anchor electrode region 404. Additionally, a second anchor electrode region 402 may be positioned above, such as on top of, the first shield electrode region 210. Similarly, the multilayer capacitor 400 may include a third anchor electrode region 406 below, such as immediately below, the active electrode region 14. Further, a second shield electrode region 212 containing a shield electrode layer 26 may be positioned below, such as immediately below, the third anchor electrode region 406. Additionally, a fourth anchor electrode region 408 may be positioned below, such as immediately below, the second shield electrode region 212. In this regard, the active electrode region 14 may be disposed between the first anchor electrode region 404 and the third anchor electrode region 406, for example. The active electrode region 14 may be configured as described above with reference to FIGS. 1, 2A, 2B, and 2C.

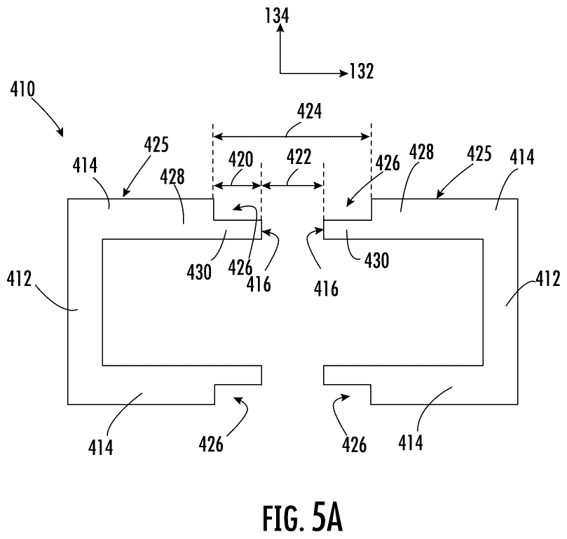

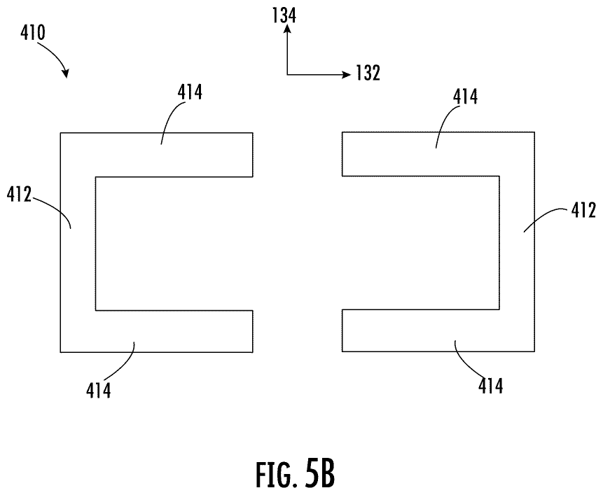

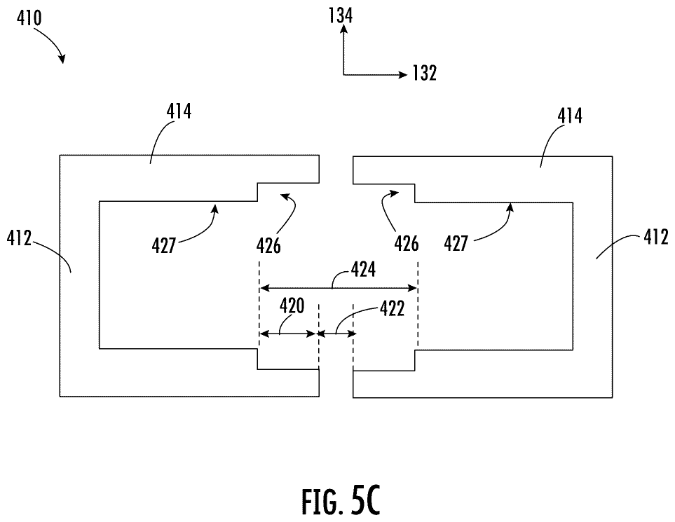

Referring to FIG. 5A, the anchor electrode regions 402, 404, 406, and/or 408 may include a plurality of anchor electrode layers 410, each having a pair of anchor electrodes 412. The anchor electrodes 412 may include a pair of electrode arms 414. Each electrode arm 414 of the anchor electrodes 412 may include a main portion 428 and a step portion 430. More specifically, an electrode arm 414 of the first anchor electrode 412 may include a first longitudinal edge 416 that extends in the lateral direction 134 and may define an edge of the step portion 430. A second longitudinal edge 418 may extend in the lateral direction 134 and may define an edge of the main portion 428 of the arm 414. The first longitudinal edge 416 may be offset from the second longitudinal edge 418 in the longitudinal direction 132 by an arm offset distance 420. As such, the electrode arms 414 of the anchor electrodes 412 may include a step 426 that is inwardly offset from an outer lateral edge 425 of the anchor electrode 412.

One or both electrode arms 414 of the first anchor electrode 412 and/or second anchor electrode 412 may include respective main and step portions 428, 430. For example, both arms 414 of both electrodes 412 may include respective main portions 428 and step portions 430, such as illustrated in FIG. 5A. Step arm gaps 422 may be formed between the step portions 430 of aligned arms 414. Main arm gaps 424 may be formed between the main portions 428 of aligned arms 414.

Referring to FIGS. 5B and 5C, the anchor electrodes 412 may have various configurations. For example, referring to FIG. 5B, in some embodiments, the electrode arms 414 of the anchor electrodes 412 may not include a step. For instance, such electrodes may be presented in a C-shaped configuration without a step. Referring to FIG. 5C, the step 426 may be offset from an inner lateral edge 427 of the arms 414 of the anchor electrodes 412. Yet other configurations are possible. For example, in some embodiments, a step 426 may be offset from both the outer lateral edge 425 and the inner lateral edge 427.

Referring to FIG. 6, a schematic side cross-sectional view is provided of another embodiment of a broadband multilayer capacitor. Like the capacitor 100 illustrated in FIG. 1A, the multilayer capacitor 600 shown in the embodiment of FIG. 6 has a monolithic body 98 including a plurality of dielectric layers stacked in the Z-direction 136 and extending between a first end 19 and an opposite second end 21. A first external termination 118 is disposed along the first end 19 and a second external termination 21 is disposed along the second end 21. The first external termination 118 includes a first portion 140 extending along an outer surface of the monolithic body, such as the bottom surface 20, and similarly, the second external termination 120 includes a first portion 144 extending along an outer surface of the monolithic body, such as the bottom surface 20. The first portion 140 of the first external termination 118 is spaced apart from the first portion 144 of the second external termination 120 by a first external termination spacing distance 142. Likewise, in some embodiments, the first external termination 118 includes a second portion 146 extending along another outer surface of the monolithic body, such as the top surface 18, and the second external termination 120 includes a second portion 150 extending along another outer surface of the monolithic body, such as the top surface 18. The second portion 146 of the first external termination 118 is spaced apart from the second portion 150 of the second external termination 120 by a second external termination spacing distance 148. The first external termination spacing distance 142 and/or the second external termination spacing distance 148 may be configured as described with respect to the capacitor 100 shown in FIG. 1A, e.g., the first external termination spacing distance 142 may be the same as or different from the second external termination spacing distance 148 and/or may be within one of the specified ranges.

As depicted in FIG. 6, in some embodiments, the dielectric region 12 and/or the additional dielectric region 115 may be free of electrode layers that extend greater than about 40% of a length 17 of the capacitor 600 from the first end 19 or the second end 21 of the capacitor 100. For example, in such embodiments, the dielectric region 12 and/or the additional dielectric region 115 may include one or more floating electrodes and/or dummy electrode tabs. However, in other embodiments, the dielectric region 12 and/or the additional dielectric region 115 may be free of all electrode layers, for example as described above with reference to FIG. 1A.

In some embodiments, the broadband multilayer ceramic capacitor 600 may be free of shield electrodes 22, 24 above a plurality of active electrode layers 102, 104 in the Z-direction 136. For example, in some embodiments, the broadband multilayer ceramic capacitor 600 may be free of shield electrodes 22, 24 above a lowest active electrode layer 101 of the plurality of active electrode layers 102, 104 in the Z-direction 136. Further, in some embodiments, the capacitor 400 may be free of shield electrodes 22, 24 below a plurality of active electrode layers 102, 104 in the Z-direction 136. For instance, in some embodiments, the capacitor 600 may be free of shield electrodes 22, 24 below a highest active electrode layer 103 of the plurality of active electrode layers 102, 104 in the Z-direction 136.

As previously described, in some embodiments, the capacitor 600 includes dummy tab electrodes 52, 54, which may be aids to deposition and/or forming of the terminals 118, 120, for example using a fine copper terminal process. The dummy tab electrodes 52, 54 may extend less than about 40% of the capacitor length 17 from the first end 19 or the second end 21. For instance, in some embodiments the dummy tab electrodes 52, 54 may extend less than about 40% of the capacitor length 17, in some embodiments less than about 30%, in some embodiments less than about 25%, in some embodiments less than about 20%, in some embodiments less than about 15%, and in some embodiments less than about 10%. Additionally, in some embodiments, the region 115 between the shield electrode region 16 and the active electrode region 14 may include dummy tab electrodes 55, 57, which may be configured similarly to the dummy tab electrodes 52, 54.

In some embodiments, the capacitor 100 may include one or more floating electrodes. In the embodiment of FIG. 6, a floating electrode 152 is positioned in the dielectric region 12. However, in other embodiments, the one or more floating electrodes 152 may be positioned in the active electrode region 14. In general, such floating electrodes 152 are not directly connected to an external termination 118, 120. The floating electrode(s) 152 may be positioned and configured according to any method known in the art. For instance, the one or more floating electrodes may be provided such that the floating electrode(s) overlap at least a portion, such as a central portion, of a first active electrode and/or a second active electrode of an active electrode layer. In this regard, the floating electrode layer is layered and disposed alternately with the first electrode layers and the second electrode layers; in this regard, such layers may be separated by the dielectric layers. In addition, such floating electrodes may have any shape as generally known in the art. For instance, in one embodiment, the floating electrode layers may include at least one floating electrode having a dagger like configuration. In another embodiment, a floating electrode may be similar to the configuration and shape of the first active electrode layers 102 as described herein.

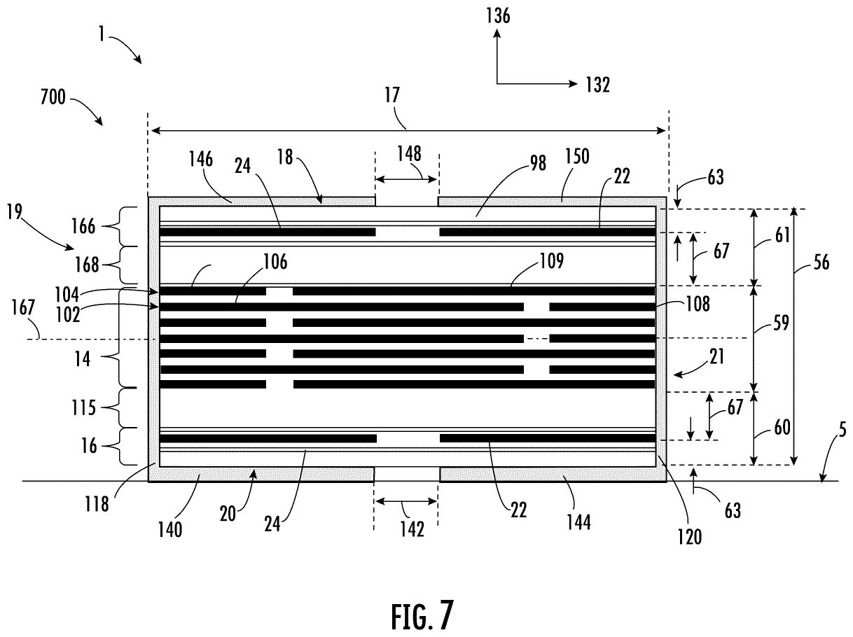

FIG. 7 illustrates another example embodiment of a capacitor 700 according to aspects of the present disclosure. The capacitor 700 generally may be similar to the capacitor 100 of FIG. 1A, except the capacitor 700 of FIG. 7 may include an additional shield electrode region 166 and, as further described with respect to FIGS. 8A through 8C, may include first active electrode layers 102 having two active electrodes 106, 108 and second active electrode layers 104 having two active electrodes 107, 109. The capacitor 700 generally may be symmetric about a longitudinal centerline 165. The additional shield electrode region 166 generally may be configured like the shield electrode region 16. A dielectric region 168 between the active electrode region 14 and the additional shield electrode region 166 may generally be free of electrode layers or free of electrode layers that extend more than 40% of the length 17 of the capacitor 700 (e.g., the region 168 may include dummy electrodes in some embodiments). The capacitor 700 may be mounted to a mounting surface 5 of a device 1 as shown in FIG. 7 and as described in more detail with respect to FIG. 1A.

As previously stated, in some embodiments of a capacitor as described herein, each active electrode layer 102, 104 may include one or more active electrodes, as shown with respect to capacitor 700 in FIG. 7. FIG. 8A illustrates an exploded perspective view of one embodiment of an active electrode pattern for one or more electrodes in the active electrode region 14 according to aspects of the present disclosure. As shown in the embodiment of FIG. 8A, a first electrode layer 102 includes a first active electrode 106 and a second active electrode 108. The first active electrode 106 may be connected with the first external termination 118 (FIG. 7), and the second active electrode 108 may be connected with the second external termination 120 (FIG. 7). Dielectric material 124 separates the first active electrode 106 from the second active electrode 108 within the first active electrode layer 102.

As further shown in FIG. 8A, a second electrode layer 104 may be configured similarly to the depicted first electrode layer 102 of the capacitor 700. In the embodiment shown, the illustrated second electrode layer 104 includes a third active electrode 107 and a fourth active electrode 109. The third active electrode 107 may be connected with the first external termination 118 (FIG. 7), and the fourth active electrode 109 may be connected with the second external termination 120 (FIG. 7). Dielectric material 124 separates the third active electrode 107 from the fourth active electrode 109 within the second active electrode layer 104.

As further illustrated in FIG. 8A, the first active electrode 106 can be co-planar with the second active electrode 108. Similarly, the third active electrode 107 can be co-planar with the fourth active electrode 109. Further, the first active electrode 106 can overlap the fourth active electrode 109 in the longitudinal direction 132. The first active electrode 106 can overlap the fourth active electrode along an overlap distance 122 (FIG. 7). As shown in FIGS. 7 and 8A, in at least some embodiments, the multilayer capacitor 700 may contain alternating first active electrode layers 102 and second active electrode layers 104. The side cross-sectional view of FIG. 7 illustrates a capacitor 700 having a total of four first electrode layers 102 and three second electrode layers 104. However, it should be understood that any number of electrode layers 102, 104 may be employed to obtain the desired capacitance for the desired application.

Referring to FIGS. 8B and 8C, a capacitive region may be formed between the first active electrode 106 and the second active electrode 108 of the first electrode layer 102, and a capacitive region may be formed between the third active electrode 107 and the fourth active electrode 109 of the second electrode layer 104. More particularly, in the embodiment illustrated in FIGS. 8B and 8C, an end gap distance 110 is defined between an end 112 of the first active electrode 106 and an end 114 of the second active electrode 108, and an end gap distance 111 is defined between an end 113 of the third active electrode 107 and an end 117 of the fourth active electrode 109. As shown in the embodiment of FIG. 8B, a capacitive region 116 may be formed between the end 112 of the first active electrode 106 and the end 114 of the second active electrode 108. Moreover, as shown in the embodiment of FIG. 8C, a capacitive region 119 may be formed between the end 113 of the third active electrode 107 and the end 117 of the fourth active electrode 109.

Referring to FIG. 9, a schematic side cross-sectional view is provided of another embodiment of a capacitor 900. It will be appreciated that the capacitor 900 may be similar to the capacitor 100 described above with respect to FIG. 1A. However, the capacitor 900 illustrated in FIG. 9 lacks a shield electrode region 16 and includes more active electrode layers 102, 104 than in the embodiment illustrated in FIG. 1A. Thus, as previously described, some embodiments of a multilayer ceramic capacitor may be provided without shield electrodes and with any suitable number of active electrode layers. As also shown in FIG. 9, the capacitor 900 may be mounted in a device 1 to a mounting surface 5 as shown in FIG. 9 and as described in more detail with respect to FIG. 1A.

Further, the dielectric region 12 between the active electrodes 102, 104 and the top surface 18 and bottom surface 20 of the capacitor 900 is relatively thin, e.g., such that an outermost-active-to-surface distance 60 between an outermost active electrode layer and an outer surface (such as between the lowest active electrode layer 101 and the bottom surface 20 as shown in FIG. 9) is relatively small. For instance, a ratio of the capacitor thickness 56 to the outermost-active-to-surface distance 60 may be greater than about 2. For example, in some embodiments, the ratio of the capacitor thickness 56 to the outermost-active-to-surface distance 60 may be 1.1 or more, in some embodiments 2 or more, in some embodiments 3 or more, in some embodiments 5 or more, in some embodiments 10 or more, in some embodiments 20 or more, in some embodiments 30 or more, in some embodiments 40 or more, and in some embodiments 50 or more. Moreover, in some embodiments, the outermost-active-to-surface distance 60 may be 150 microns or less, in some embodiments 125 microns or less, in some embodiments 100 microns or less, in some embodiments 90 microns or less, in some embodiments 75 microns or less, in some embodiments 60 microns or less, in some embodiments 40 microns or less, in some embodiments 25 microns or less, in some embodiments 15 microns or less, in some embodiments 10 microns or less, and in some embodiments 5 microns or less.

### II. TEST METHODS

A testing assembly can be used to test performance characteristics, such as insertion loss and return loss, of a capacitor according to aspects of the present disclosure. For example, the capacitor can be mounted to a test board. An input line and an output line can each be connected with the test board. The test board can include microstrip lines electrically connecting the input line and output lines with respective external terminations of the capacitor.

An input signal can be applied to the input line using a source signal generator (e.g., an 1806 Keithley 2400 series Source Measure Unit (SMU), for example, a Keithley 2410-C SMU) and the resulting output signal of the capacitor can be measured at the output line (e.g., using the source signal generator). This was repeated for various configurations of the capacitor to generate insertion loss curves such as described below with respect to Examples 1 through 3.

### III. EXAMPLES

### Example 1

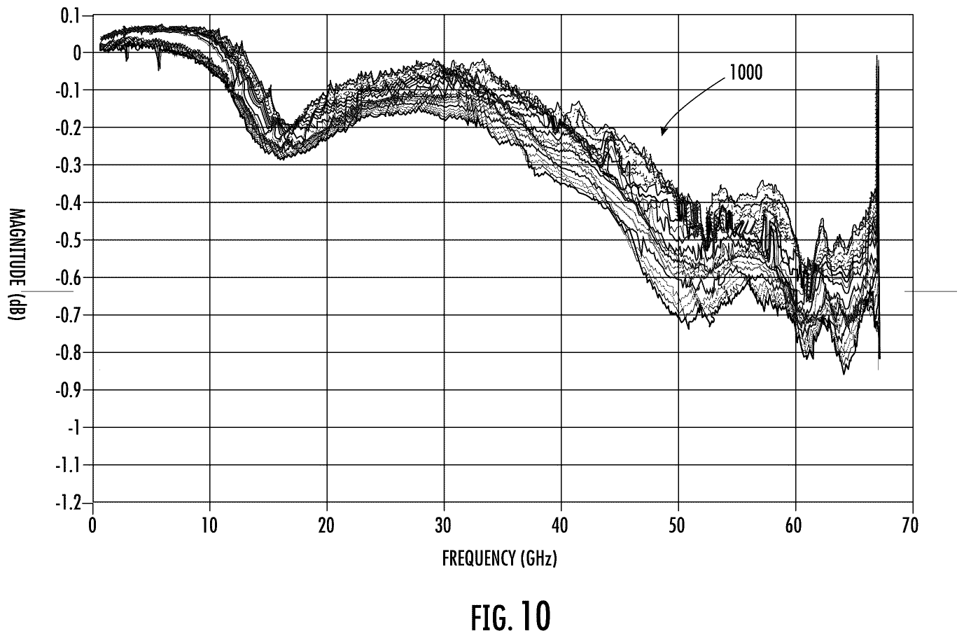

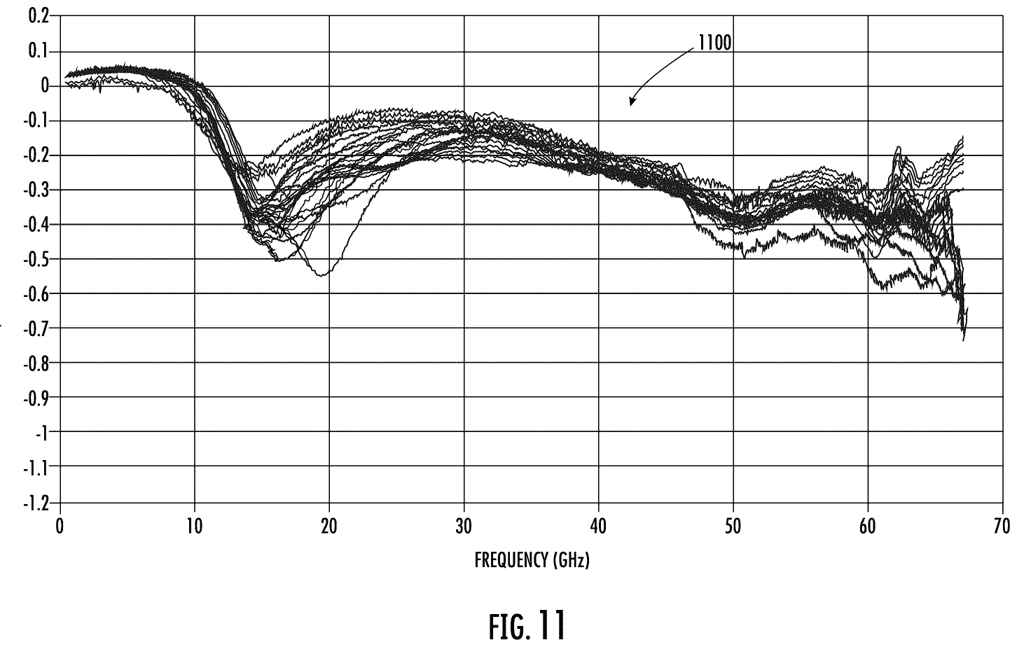

FIG. 10 illustrates a plurality of insertion loss response curves 1000 (S₂₁) for a plurality of broadband multilayer ceramic capacitors 100 of FIG. 1A having an 0201 case size and a capacitance of 220 nF. The plurality of capacitors 100 had an outermost-active-to-surface distance 60 of about 1.2 mils or 30.5 microns. Each capacitor 100 of the plurality of capacitors 100 was mounted to the test board in a horizontal orientation, with the electrodes of the capacitor 100 extending parallel with the test board.

As shown by the response curves 1000, the insertion loss of the capacitors was greater than −0.20 dB for frequencies ranging from about 1 GHz to about 12 GHz and from about 22 GHz to about 32 GHz. The insertion loss of the capacitors was greater than −0.30 dB for frequencies ranging from about 12 GHz to about 22 GHz and from about 32 GHz to about 37 GHz. The insertion loss of the capacitors was greater than −0.60 dB for frequencies ranging from about 37 GHz to about 47 GHz. The insertion loss of the capacitors was greater than −0.80 dB for frequencies ranging from about 47 GHz to about 60 GHz and was greater than about −0.90 dB for frequencies ranging from about 60 GHz to about 67 GHz.

### Example 2

FIG. 11 illustrates a plurality of insertion loss response curves 1100 (S₂₁) for a plurality of broadband multilayer ceramic capacitors 100 having an 0201 case size, a capacitance of 220 nF, and a first external termination spacing distance 142 of about 10 mils or about 250 microns. The plurality of capacitors 100 had an outermost-active-to-surface distance 60 of about 1.2 mils or 30.5 microns. Each capacitor 100 of the plurality of capacitors 100 was mounted to the test board in a horizontal orientation, with the electrodes of the capacitor 100 extending parallel with the test board.

As shown by the response curves 1100, the insertion loss of the capacitors was greater than −0.25 dB for frequencies ranging from about 1 GHz to about 15 GHz and from about 25 GHz to about 37 GHz. The insertion loss of the capacitors was greater than −0.50 dB for frequencies ranging from about 15 GHz to about 25 GHz and from about 37 GHz to about 60 GHz. The insertion loss of the capacitors was greater than −0.60 dB for frequencies ranging from about 60 GHz to about 67 GHz.

### Example 3

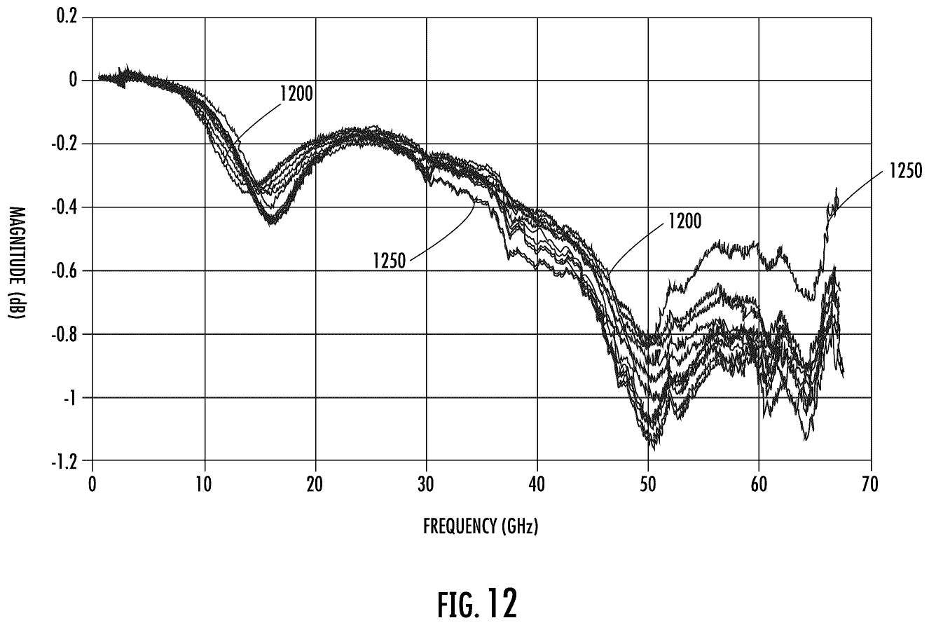

FIG. 12 illustrates a plurality of insertion loss response curves 1200 (S₂₁) for a plurality of broadband multilayer ceramic capacitors 100 having an 0201 case size, a capacitance of 100 nF, an outermost-active-to-surface distance 60 of about 1.4 mils or 35.6 microns, and a capacitor thickness 56 of 22 mm. Each capacitor 100 of the plurality of capacitors 100 was mounted to the test board in a horizontal orientation, with the electrodes of the capacitor 100 extending parallel with the test board.

FIG. 12 further illustrates a plurality of insertion loss response curves 1250 (S₂₁) for a plurality of multilayer capacitors 100 having an 0201 case size, a capacitance of 100 nF, an outermost-active-to-surface distance 60 of about 1.2 mils or 30.5 microns, and a capacitor thickness 56 of 15 mm. Each capacitor 100 of the plurality of capacitors 100 was mounted to the test board in a horizontal orientation, with the electrodes of the capacitor 100 extending parallel with the test board.

As shown by the curves 1200 in FIG. 12, the insertion loss of the 22 mm thick capacitors was greater than −0.50 dB for frequencies ranging from about 1 GHz to about 43 GHz, was greater than −1.00 dB for frequencies ranging from about 43 GHz to about 60 GHz, and was greater than −1.20 dB for frequencies ranging from about 60 GHz to about 67 GHz.

As shown by the curves 1250 in FIG. 12, the insertion loss of the 15 mm thick capacitors was greater than −0.50 dB for frequencies ranging from about 1 GHz to about 37 GHz, was greater than −1.00 dB for frequencies ranging from about 37 GHz to about 48 GHz and from about 53 GHz to about 67 GHz, and was greater than −1.20 dB for frequencies ranging from about 48 GHz to about 53 GHz.

These and other modifications and variations of the present invention may be practiced by those of ordinary skill in the art, without departing from the spirit and scope of the present invention. In addition, it should be understood that aspects of the various embodiments may be interchanged both in whole or in part. Further, those of ordinary skill in the art will appreciate that the foregoing description is by way of example only and is not intended to limit the invention so further described in such appended claims.

What is claimed is:

1. A broadband multilayer ceramic capacitor comprising:
a monolithic body including a plurality of dielectric layers stacked in a Z-direction, the monolithic body having a first end opposite a second end;
a first external termination disposed along the first end of the monolithic body, the first external termination including a first portion extending along an outer surface of the monolithic body;
a second external termination disposed along the second end of the monolithic body, the second external termination including a first portion extending along the outer surface of the monolithic body, the first portion of the first external termination spaced apart from the first portion of the second external termination by a first external termination spacing distance; and
an active electrode region containing a plurality of first active electrode layers and a plurality of second active electrode layers, the plurality of first active electrode layers including at least one active electrode that is rectangular in shape and the plurality of second active electrode layers including at least one second active electrode that is rectangular in shape, the plurality of first active electrode layers connected with the first external termination and the plurality of second active electrode layers connected with the second external termination,
wherein the active electrode region contains an outermost active electrode layer, the outermost active electrode layer being spaced apart from the outer surface by an outermost-active-to-surface distance,
wherein the monolithic body has a thickness along the Z-direction,
wherein a ratio of the thickness to the outermost-active-to-surface distance is 1.1 or more,
wherein the capacitor has a capacitor length extending in a longitudinal direction, and
wherein a ratio of the capacitor length to the first external termination spacing distance is 15 or more.

2. The broadband multilayer ceramic capacitor of claim 1, wherein the outermost-active-to-surface distance is 150 microns or less.
wherein a ratio of the capacitor length to the first external termination spacing distance is 15 or more.

3. The broadband multilayer ceramic capacitor of claim 1, wherein the first external termination spacing distance is 250 microns or less.

4. The broadband multilayer ceramic capacitor of claim 1, wherein the broadband multilayer ceramic capacitor is configured for mounting to a mounting surface with each first active electrode layer of the plurality of first active electrode layers and each second active electrode layer of the plurality of second active electrode layers extending parallel to the mounting surface.

5. The broadband multilayer ceramic capacitor of claim 4, wherein the broadband multilayer ceramic capacitor exhibits an insertion loss greater than about −1.2 dB from about 5 GHz to about 67 GHz.

6. The broadband multilayer ceramic capacitor of claim 1, wherein the outer surface is a bottom surface of the monolithic body.

7. The broadband multilayer ceramic capacitor of claim 1, wherein the outer surface is a top surface of the monolithic body.

8. The broadband multilayer ceramic capacitor of claim 1, further comprising a shield electrode region located between the active electrode region and the outer surface.

9. The broadband multilayer ceramic capacitor of claim 1, further comprising a dielectric region located between the active electrode region and a second outer surface of the monolithic body in the Z-direction.

10. The broadband multilayer ceramic capacitor of claim 9, wherein the second outer surface is opposite the outer surface along the Z-direction.

11. The broadband multilayer ceramic capacitor of claim 9, wherein dielectric region is free of electrode layers that extend greater than 40% of the capacitor length from the first end of the monolithic body or the second end of the monolithic body.

12. The broadband multilayer ceramic capacitor of claim 9, wherein the dielectric region is free of electrode layers.

13. The broadband multilayer ceramic capacitor of claim 1, further including at least one floating electrode not connected with the first external termination or the second external termination, wherein the at least one floating electrode is disposed within a dielectric region located between the shield electrode region and a top surface of the capacitor in the Z-direction.

14. The broadband multilayer ceramic capacitor of claim 1, wherein the broadband multilayer ceramic capacitor exhibits an insertion loss greater than about −1.0 dB at about 67 GHz.

15. The broadband multilayer ceramic capacitor of claim 1, wherein the broadband multilayer ceramic capacitor exhibits an insertion loss greater than about −0.6 dB at about 40 GHz.

16. The broadband multilayer ceramic capacitor of claim 1, wherein the broadband multilayer ceramic capacitor exhibits an insertion loss greater than about −0.2 dB at about 10 GHz.

17. The broadband multilayer ceramic capacitor of claim 1, wherein the broadband multilayer ceramic capacitor exhibits an insertion loss greater than about −0.5 dB from about 5 GHz to about 20 GHz.

18. The broadband multilayer ceramic capacitor of claim 1, wherein the broadband multilayer ceramic capacitor exhibits an insertion loss greater than about −0.6 dB from about 20 GHz to about 40 GHz.

19. The broadband multilayer ceramic capacitor of claim 1, wherein the broadband multilayer ceramic capacitor exhibits an insertion loss greater than about −1.0 dB from about 40 GHz to about 50 GHz.

20. The broadband multilayer ceramic capacitor of claim 1, wherein the broadband multilayer ceramic capacitor exhibits an insertion loss greater than about −1.2 dB from about 50 GHz to about 60 GHz.

21. The broadband multilayer ceramic capacitor of claim 1, wherein the broadband multilayer ceramic capacitor exhibits an insertion loss greater than about −1.2 dB from about 60 GHz to about 67 GHz.

22. A device, comprising:
a mounting surface; and
a broadband multilayer ceramic capacitor comprising:
a monolithic body including a plurality of dielectric layers stacked in a Z-direction, the monolithic body having a first end opposite a second end;
a first external termination disposed along the first end of the monolithic body, the first external termination including a first portion extending along an outer surface of the monolithic body;
a second external termination disposed along the second end of the monolithic body, the second external termination including a first portion extending along the outer surface of the monolithic body, the first portion of the first external termination spaced apart from the first portion of the second external termination by a first external termination spacing distance; and
an active electrode region containing a plurality of first active electrode layers and a plurality of second active electrode layers, the plurality of first active electrode layers including at least one active electrode that is rectangular in shape and the plurality of second active electrode layers including at least one second active electrode that is rectangular in shape, the plurality of first active electrode layers connected with the first external termination and the plurality of second active electrode layers connected with the second external termination,
wherein the active electrode region contains an outermost active electrode layer, the outermost active electrode layer being spaced apart from the outer surface by an outermost-active-to-surface distance, wherein the monolithic body has a thickness along the Z-direction, wherein a ratio of the thickness to the outermost-active-to-surface distance is 1.1 or more, wherein the capacitor has a capacitor length extending in a longitudinal direction, and wherein a ratio of the capacitor length to the first external termination spacing distance is 15 or more,
wherein the broadband multilayer ceramic capacitor is mounted to the mounting surface in a horizontal orientation such that each active electrode layer of the plurality of active electrode layers extends parallel to the mounting surface.

23. The device of claim 22, wherein each first active electrode layer of the plurality of first active electrode layers includes at least one active electrode that is rectangular in shape.

24. The device of claim 22, wherein each second active electrode layer of the plurality of second active electrode layers includes at least one active electrode that is rectangular in shape.

25. The device of claim 22, wherein the outermost-active-to-surface distance is 100 microns or less and the first external termination spacing distance is 75 microns or less.

26. A method of forming a broadband multilayer ceramic capacitor, the method comprising:
forming a plurality of active electrodes on a plurality of active electrode layers, wherein at least one first active electrode layer of the plurality of active electrode layers comprises a first active electrode and at least one second active electrode layer of the plurality of active electrode layers comprises a second active electrode;
stacking the plurality of active electrode layers and a plurality of dielectric layers to form a monolithic body having an outer surface, the plurality of active electrode layers including an outermost active electrode layer disposed closest to the outer surface of the monolithic body of the plurality of active electrode layers;
depositing a first external termination along a first end of the capacitor, the first external termination connected with the first active electrode layer, the first external termination including a first portion extending along the outer surface of the capacitor; and
depositing a second external termination along a second end of the capacitor that is opposite the first end, the second external termination connected with the second active electrode layer, the second external termination including a first portion extending along the outer surface of the capacitor,
wherein the outermost active electrode layer is spaced apart from the outer surface by an outermost-active-to-surface distance,
wherein the monolithic body has a thickness along the Z-direction,
wherein a ratio of the thickness to the outermost-active-to-surface distance is 1.1 or more,
wherein the capacitor has a capacitor length extending in a longitudinal direction, and
